(19) United States
(12) Patent Application Publication
(10) Pub. No.: US 2017/0182465 A1
(43) Pub. Date: Jun. 29, 2017

(54) WATER TREATMENT METHOD AND WATER TREATMENT APPARATUS EACH USING MEMBRANE

(71) Applicant: Mitsubishi Electric Corporation, Chiyoda-ku (JP)

(72) Inventors: Nozomu YASUNAGA, Chiyoda-ku (JP); Seiji FURUKAWA, Chiyoda-ku (JP)

(73) Assignee: Mitsubishi Electric Corporation, Chiyoda-ku (JP)

(21) Appl. No.: 15/302,096

(22) PCT Filed: Apr. 6, 2015
(86) PCT No.: PCT/JP2015/060710

§ 371 Date: Oct. 5, 2016

(30) Foreign Application Priority Data
Apr. 10, 2014 (JP) 2014-080735

(51) Int. Cl. B01D 65/02; C02F 1/44

(52) U.S. Cl. CPC B01D 65/02; C02F 1/44; B01D 2321/04; B01D 2321/162; B01D 2321/16; C02F 2303/16

(57) ABSTRACT

Ozonated washing water is generated by injecting an ozone gas into pressurized washing water that is filtered water obtained by membrane filtration of untreated water and that is to be used at the time of backwashing, and the ozonated washing water is supplied to a membrane from the filtration secondary side to thereby remove a fouling substance inside the membrane, while causing ozone-containing bubbles to emerge in the filtration primary side to thereby remove a fouling substance on a membrane surface in the filtration primary side.

### TECHNICAL FIELD

The present invention relates to a water treatment method and a water treatment apparatus each using a membrane, for treating clean water, industrial water, sewage, sewage secondary effluent, plant wastewater, seawater, human waste or the like, by subjecting it to membrane filtration, and in particular, relates to washing of the membrane.

### BACKGROUND ART

In the case where water is treated by membrane filtration to thereby remove a foreign substance and the like in the water, when this treatment is performed continuously, the membrane is clogged to increase the filtration pressure, resulting in decrease of an amount of the filtered water. Here, the foreign substance is a generic term of all of those separated off through membrane filtration processing from the membrane-filtration treatment water at the time of membrane filtration treatment, examples of which include sludge that is a mass of microorganisms (hereinafter, the same applies), an SS (abbreviation of Suspended Solid that means suspended solid substances; hereinafter, the same applies) in the water to be treated, and the like. Note that the volume of the filtered water per unit time and per unit membrane-filtration area is hereinafter called as a flux. Although clogging of the membrane is due to the foreign substance in the water, microorganisms adhered to the membrane surface or the inside of the membrane, metabolites of these microorganisms, or the like, it is necessary to remove them by periodically washing the membrane, in order to ensure the value of the flux at design time of the membrane filtration facility, for example, 0.2 to 5.0 m³/day.

For that reason, in order to ensure the flux, a backwashing process is executed in which the membrane is washed in such a manner that clear water, such as membrane-filtered water, tap water or the like, is brown out through the membrane in a direction that is opposite to its filtering direction (a flow direction of the water to be treated, when the water to be treated is filtered). Namely, during the membrane filtration treatment, the water flows from the primary side to the secondary side of the membrane so as to be treated by filtration, whereas in the backwashing process, clear water is caused to flow from the secondary side to the primary side to thereby remove stains of the membrane. Here, the clear water means water, such as, tap water, membrane-filtered water, well water, or effluent of wastewater/sewage-treatment plant, which has a turbidity of less than 1 or an SS of less than 1 mg/L (hereinafter, the same applies). Further, the primary side is a region where untreated water exists, and the secondary side is a region where filtered water exists (in this invention, the filtered water means water after subjected to filtration). Namely, across the membrane, the to-be-filtered side is the primary side and the filtered side is the secondary side. With respect to a backwashing method, if the clogging is physical one, its backwashing is allowable using the clear water, such as the filtered water (water subjected to filtration), the tap water or the like; however, an adhered substance chemically coupled to the membrane surface or the inside of the membrane can not be removed.

For that reason, the following backwashing methods have been applied. They include: a method of using a sodium hypochlorite solution that is known as a typical agent for water treatment; a method of additionally using an oxalic acid or a citric acid; and furthermore, a method in which ozone water is generated which is then used as backwashing water, as shown in Patent Document 1; and further, a method of backwashing using ozone water while introducing bubbles into the primary side of the membrane to thereby vibrate the membrane, as shown in Patent Document 2.

### CITATION LIST

### Patent Document

Patent Document 1: Japanese Patent Application Laid-open No. 2001-70761
Patent Document 2: Japanese Patent Application Laid-open No. 2001-79365
Patent Document 3: Japanese Patent Application Laid-open No. H05-305221

### SUMMARY OF THE INVENTION

### Problems to be Solved by the Invention

However, according to the conventional backwashing methods (see, Patent Documents 1 and 2), it is insufficient to remove the adhered substance (fouling substance) inside the membrane and on the membrane surface (primary side). Namely, according to the conventional backwashing method using ozone water as clear water, because the ozone water is generated at atmospheric pressure while separating off an undissolved ozone gas as a waste ozone gas, even if the ozone water concentration is increased, the ozone water concentration will be lowered to 0.01 to 3 mg/L at the time the ozone water actually reaches the inside of the membrane and the membrane surface, and even further if the ozone water is pressurized using a pump and then supplied to the inside of the membrane and the membrane surface, the ozone water concentration will not be higher than the above. This is because the ozone water is generated at atmospheric pressure (the ozone water concentration can not be increased without dissolution of an ozone gas). As a result, the reaction between the fouling substance and ozone does not sufficiently proceed. Further, also because the pressure is low, the reaction between the fouling substance and ozone is not promoted. Furthermore, at the time the backwashing water flows out from the primary side after flowing into the secondary side of the membrane, because dissolved ozone has been already consumed by the reaction with the fouling substance in the membrane, it is unable to cause ozone-containing bubbles to emerge on the membrane surface in the primary side, so that the fouling substance on the membrane surface can not be removed. This is because the fouling substance on the membrane surface can only be removed when ozone is contained in bubbles in a manner oxdatively decomposed using oxidation power of ozone. Note that the fouling substance means a metabolite product of a microorganism, in which polysaccharides, proteins and the like are included, for example (hereinafter, the same applies).

Meanwhile, according to the conventional backwashing method (see, Patent Document 3), although the membrane is washed using backwashing water in which an ozone gas was injected by an injector, and the pressure in the washing unit is increased using a back pressure valve, because of associating with the ozone gas, the ozone gas is accumulated in the pipe, so that the inside of the membrane can not be washed uniformly. Furthermore, ozone water capable of washing the inside of the membrane is a part of the washing water capable of passing through the inside of the membrane and thus, most of the ozone water moves to a gas-liquid separation tank. Even when trying to increase the ozone water passing toward the inside of the membrane using the back pressure valve, because the ozone gas is accumulated in the pipe as described above, the inside of the membrane can not be washed uniformly. Furthermore, because the ozone water in which the ozone gas was injected will return to a treated water tank through the gas-liquid separation tank, ozone water used for washing the inside of the membrane is a part thereof, so that the utilization efficiency of ozone is poor.

Further, when the treated water (membrane-filtered water) is used as backwashing water, ozone is consumed by the organic substance in the treated water, so that the concentration of ozone in the water can not be increased and thus a sufficient washing effect of the membrane can not obtained (see, patent Documents 1, 2 and 3). Note that at the time ozone is consumed by washing, oxygen is being dissolved, so that it emerges as a gas from the membrane surface (primary side) in some cases; however, a washing effect of the membrane surface (primary side) can not be obtained by oxygen.

Further, according to the method in which the primary side of the membrane is aerated, although the microorganisms adhered to the membrane are partly broken away due to impulsion force of the aerated bubbles; however, because the fouling substance on the membrane surface is, for example, a high-molecular organic substance as the microorganism metabolite, it can not be removed only by the impulsion force of the bubbles. Namely, the high-molecular organic substance as the microorganism metabolite can not be removed by the contact of the bubbles with the high-molecular organic substance as the microorganism metabolite, or by a force of water flow caused or the movement of the bubbles. Furthermore, it is also unable to remove microorganisms adhered to the membrane surface through the microorganism metabolite (see, Patent Documents 1 and 2).

Although the membrane surface (primary side) is further washed by bubbling using an ozone gas, the used ozone gas is that which is included in the ozone gas injected into the water for backwashing but is not dissolved therein. Thus, the ozone gas concentration is low and the bubble diameter is as large as in the order from several mm to several cm, so that the washing effect of the membrane surface (primary side) is insufficient (see, Patent Document 3).

Furthermore, because the flow-through passage of the backwashing water is the same as that of the filtered water, the pressure in the primary side of the membrane differs with respect to the up-down direction given as a water-depth direction, so that it is unable to wash the inner area of the membrane surface uniformly in the water-depth direction.

Likewise, when membrane units that are assembled together into multiple stages in the water-depth direction, are to be backwashed at the same time, the respective membrane units with different water depths can not be washed uniformly therebetween. Here, what is referred to as the membrane is a sheet-like or hollow fiber-like object having micropores with a pore size of 0.001 to 0.5 μm; an assembled object in which, in order to allow the membrane to filter water, a pipe and the like are attached thereto, is referred to as a membrane module; and an assembled object of some of the membrane modules is referred to as the membrane unit.

If the fouling substances inside the membrane and on the membrane surface can not be removed, the degree of recovery in transmembrane pressure difference decreases, so that the flux gradually decreases. Here, what is referred to as the transmembrane pressure difference is a difference between the pressure in the secondary side of the membrane and the atmospheric pressure at the time of membrane filtration treatment. Note that in this invention, the transmembrane pressure difference is shown as an absolute value as indication, unless otherwise specified. Further, when backwashing is repeated, non-removable fouling substances inside the membrane and on the membrane surface are accumulated, so that the flux value at design time of the membrane filtration facility, for example, 0.2 to 5.0 m³/day, will not be obtained. This causes a need for execution of off-line washing with chemical liquid, or, if the transmembrane pressure difference does not recover even by that execution, a need for replacement of the membrane. Accordingly, in order to ensure the flux value at design time of the membrane filtration facility, for example, 0.2 to 5.0 m³/day, for a long period of several tens of days to several hundreds of days, it is necessary to properly remove by backwashing the fouling substances inside the membrane and on the membrane surface.

This invention has been made to solve the problems as described above, and an object thereof is to provide a membrane washing method and a membrane washing apparatus by which, at the washing of a membrane in a membrane filtration facility for treating the water to be treated by membrane filtration, the fouling substances inside the membrane and on the membrane surface can be properly removed by backwashing.

### Means for Solving the Problems

A water treatment method using a membrane according to the invention comprises:

pressuring clear water treated by membrane filtration to prepare washing water;

injecting an ozone gas into the washing water to generate ozonated washing water; and

supplying the ozonated washing water from a filtration secondary side which is an exit side of filtered water at the time of the membrane filtration, to a membrane for the membrane filtration, to thereby wash an inside of the membrane,

while causing ozone-containing bubbles to emerge in a filtration primary side which is an entry side of untreated water at the time of the membrane filtration, to thereby wash a surface of the membrane in the filtration primary side.

Further, a water treatment apparatus using a membrane according to the invention comprises:

a membrane filtration-separation device that separates from each other, a foreign substance contained in untreated water not treated by membrane filtration and filtered water after the membrane filtration;

a switching valve for switching between the membrane filtration that is normal and backwashing that is washing in a direction opposite to that of the normal membrane filtration;

an ozone dissolver that uses washing water prepared by pressurizing clear water treated by membrane filtration, that generates ozonated washing water by dissolving an ozone gas in the washing water, and that is connected to a pipe for supplying the ozonated washing water to the membrane filtration-separation device;

a washing-water supply pump connected to the ozone dissolver through a pipe, for supplying the washing water thereto; and

an ozone generator that supplies the ozone gas to the ozone dissolver;

wherein the ozonated washing water is supplied to a membrane for the membrane filtration in a backwashing manner by switching the switching valve from a direction of the normal membrane filtration, to thereby wash the membrane.

### Effect of the Invention

As described above, according to the water treatment method and the water treatment apparatus each using a membrane in accordance with the invention, because an ozone gas is injected into the washing water that is pressurized clear water to thereby dissolve ozone in the washing water, it is possible to cause the ozone-containing bubbles to emerge entirely from the membrane surface that is in contact with the water to be treated in the primary side of the membrane. Thus, the membrane-surface fouling substance in the primary side of the membrane is removed in a uniform manner over the inner area of the surface (here, this means the whole membrane surface in contact with the water to be treated), and also, a fouling substance is prevented from adhesion, so that the washing effect can be enhanced.

Further, because supersaturated ozone water is used, it is possible to promote the reaction between the in-membrane fouling substance in the secondary side of the membrane and ozone, by the high concentration ozone water. Further, because ozone returns to oxygen after consumed by the reaction with the fouling substance, it is possible to enhance the concentration of dissolved oxygen in a tank for water to be treated.

Further, the flow rate for aeration can be reduced at the time of backwashing, to thereby achieve energy saving.

Furthermore, the flux at the design time is generally set higher because a reduction in flux of the membrane is supposed; however, in the case of pressurizing the ozone gas when it is injected into the washing water, the washing effect of the membrane is higher than otherwise, so that the flux can be maintained to be high. This allows reducing the area required for the membrane. Namely, the required number of membrane modules or membrane units can be reduced, so that the membrane filtration device can be downsized.

### BRIEF DESCRIPTION OF THE DRAWINGS

FIG. 1 is a block diagram showing an example in Embodiment 1 of the invention.

FIG. 2 is a diagram showing a relationship between an ozone gas concentration and an ozone concentration in backwashing water in Embodiment 1 of the invention.

FIG. 3 is a block diagram showing another example in Embodiment 1 of the invention.

FIGS. 4A and 4B are diagrams according to the invention and a conventional example, each illustrating a removing process of fouling substances inside a membrane and on a membrane surface, by ozone water.

FIG. 5 is a block diagram showing another example in Embodiment 1 of the invention.

FIG. 6 is a block diagram showing another example in Embodiment 1 of the invention.

FIG. 7 is a block diagram showing another example in Embodiment 1 of the invention.

FIG. 8 is a block diagram showing an example in Embodiment 2 of the invention.

FIG. 9 is a block diagram showing another example in Embodiment 2 of the invention.

FIG. 10 is a block diagram showing another example in Embodiment 2 of the invention.

FIG. 11 is a block diagram showing another example in Embodiment 2 of the invention.

FIG. 12 is a block diagram showing an example in Embodiment 3 of the invention.

FIG. 13 is a block diagram showing an example in Embodiment 4 of the invention.

FIG. 14 is a block diagram showing an example in Embodiment 5 of the invention.

FIG. 15 is a block diagram showing another example in Embodiment 5 of the invention.

FIG. 16 is a block diagram showing an example in Embodiment 6 of the invention.

FIG. 17 is a block diagram showing an example in Embodiment 7 of the invention.

FIG. 18 is a block diagram showing another example in Embodiment 7 of the invention.

FIG. 19 is a block diagram showing Comparative Example 1.

FIG. 20 is a block diagram showing Comparative Example 2.

FIG. 21 is a diagram showing daily variations in membrane filtration resistance according to comparative examples and examples of the intention.

FIG. 22 is a diagram showing a relationship between an ozone water concentration and a transmembrane pressure difference according to Example 2 of the invention.

FIG. 23 is a diagram showing an example of a variation in an ozone concentration in backwashing water relative to an ozone gas concentration, when the ozone gas is condensed.

FIG. 24 is a diagram showing an example of a ratio of an ozone concentration in backwashing water to an ozone gas concentration, relative to the ozone gas concentration, when the ozone gas is condensed.

FIG. 25 is a diagram showing an example of a washing volume ratio relative to an ozone gas concentration required for the transmembrane pressure difference to recover to its original state, when the ozone gas is condensed.

### MODES FOR CARRYING OUT THE INVENTION

Hereinafter, embodiments for carrying out the invention will be described using the drawings.

### Embodiment 1

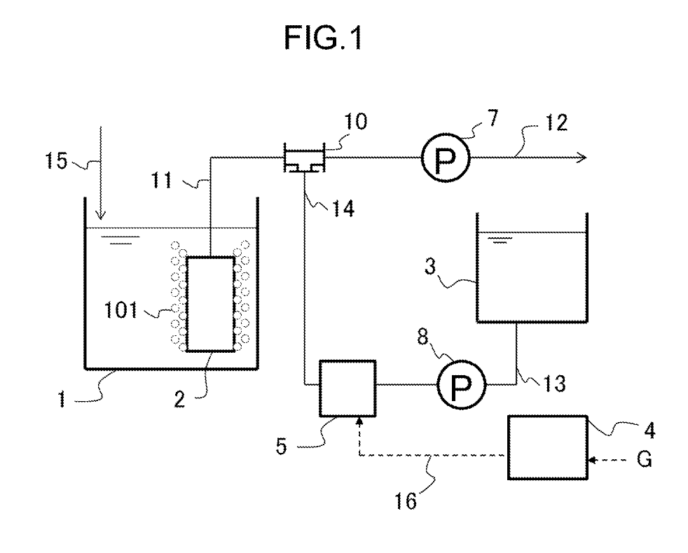

FIG. 1 is a block diagram showing Embodiment 1 of the invention. According to the configuration of this embodiment, a membrane filtration-separation device 2 is dipped in a tank for water to be treated 1 and is connected to a switching valve 10 through a membrane connection pipe 11. From the switching valve 10, a filtered water pipe 12 and an ozonated water pipe 14 are branched, so that the filtered water pipe 12 is connected to the switching valve 10 and a filtration pump 7 is placed on the pipe line of the filtered water pipe 12. Further, to the ozonated water pipe 14, an ozone mixing tank 5 that is an ozone dissolver is connected. Further, to the upstream side thereof, a washing water tank 3 is connected through a washing water pipe 13, and a washing-water supply pump 8 is provided on the washing water pipe 13 between the ozone mixing tank 5 and the washing water tank 3. Further, to the ozone mixing tank 5, an ozone generator 4 that is an ozone generation unit is connected through an ozone gas pipe 16. To the ozone generator 4, an oxygen-containing gas indicated by the mark G is normally supplied unless specifically commented below. Furthermore, on the upper side of the tank for water to be treated 1, an exit port of a pipe for water to be treated 15 is placed. Note that it is preferable that the membrane filtration-separation device 2, the ozone mixing tank 5, the ozonated water pipe 14, the switching valve 10, the membrane connection pipe and the ozone gas pipe 16 have ozone resistance characteristics.

Next, operations will be described. When membrane filtration treatment is being executed, water to be treated is sent into the tank for water to be treated 1 through the pipe for water to be treated 15 (here, the water to be treated means water passing through the pipe for water to be treated 15; hereinafter, the same applies). By means of the filtration pump 7, the water to be treated is filtered through the membrane filtration-separation device 2, and the treated water having been filtered goes through the switching valve 10 by way of the membrane connection pipe 11 and is then taken through the filtered water pipe 12. When the membrane filtration treatment is performed continuously, the membrane will be clogged, so that it is necessary to perform backwashing periodically (at a frequency of once per several hours to several weeks or several months; this varies depending on a condition in design/operation, a water quality of the water to be treated, or the like). When the membrane is clogged, the filtration pump 7 is suspended and, upon switching the switching valve 10 so that the membrane connection pipe 11 and the ozonated water pipe 14 are connected to each other, a backwashing process is started.

Note that it is allowable to set so that the transmembrane pressure difference is measured and switching to the backwashing process is made when the transmembrane pressure difference increases up to 20 kPa, for example. Also, it is allowable to establish before switching, a time period during which the membrane filtration-separation device 2 is standing still without performing membrane filtration treatment. Note that, “standing still” means that the filtration pump 7 is suspended, so that no filtration is performed. At that time, when the membrane filtration-separation device 2 is aerated with air in a direction from below (in a direction from just beneath the membrane filtration-separation device 2), a removing effect of the substance adhered to the membrane surface is expected. At that time, aeration may be executed intermittently.

Further, in order to measure an ozone water concentration of the ozone-containing washing water, an ozone concentration monitor may be placed on the membrane connection pipe 11 or the ozonated water pipe 14. Instead, it is also allowable to provide a bypass line to the membrane connection pipe 11 or the ozonated water pipe 14, and to place the ozone concentration monitor on that line. In this case, the ozone water that passed the ozone concentration monitor is returned to the membrane connection pipe 11 or the ozonated water pipe 14.

Furthermore, the ozone gas concentration may be controlled based on the value of the ozone concentration monitor. Namely, the ozone water concentration varies depends on the water quality of the treated water (membrane-filtered water) to be used as the washing water, and thus, if the value of the ozone concentration monitor is lower than a specified value (for example, 3 mg/L), increasing the ozone gas concentration makes it possible to efficiently generate and use ozone while keeping sufficient washing ability.

Here, the backwashing process of the membrane filtration-separation device proceeds in the following manner. The washing water stored in the washing water tank 3 is sent to the ozone mixing tank 5 while being pressurized by the washing-water supply pump 8, through the washing water pipe 13. Here, although the washing water generally means filtered water to be used at the time of backwashing the membrane, it maybe other clear water such as tap water.

In the ozone mixing tank 5, an ozone-containing gas (hereinafter, referred to as an ozone gas) generated by the ozone generator 4 is mixed with the washing water and thus ozone is dissolved in the water, so that ozonated washing water is generated. At that time, since a high concentration ozone gas having an ozone gas concentration of 30 g/Nm³ is used, a gas-to-liquid ratio (a ratio of ozone-gas flow rate to the washing water) can be made small (the reason why it can be made small is that the ozone gas concentration is set to a high concentration of, for example, 30 g/Nm³ or more, so that the gas volume necessary to obtain a same ozone amount becomes smaller). Thus, and also because of being pressurized, when the ozone gas is injected into the pressurized washing water, ozone can be dissolved highly efficiently more than otherwise.

Further, even if ozone is consumed because of being pressurized, through the reaction with an organic substance in the washing water, because the ozone gas concentration is high, the ozone water concentration can be kept high also in the water. Note that it is also allowable to incorporate, before using the ozonated washing water, a backwashing process only using the filtered water. Further, it is also allowable to execute a backwashing process of the membrane only using the filtered water, not using the ozonated washing water, followed by transition to the membrane filtration treatment. It is also allowable to use the ozonated washing water when the transmembrane pressure difference does not sufficiently recover solely by the backwashing process only using the filtered water.

As a result, in the case where there is no undissolved gas or the ozone gas is injected into the pressurized washing water, this results in a state in which undissolved gas is less than otherwise or than in the case where the backwashing water is recovered and returned to the treated water tank, so that it is possible to supply washing water, namely, the ozonated washing water in this embodiment, to the membrane filtration-separation device 2 without separating the gas. As a source material of the ozone gas, liquid oxygen, oxygen generated by PSA (Pressure Swing Adsorption) or VPSA (Vacuum Pressure Swing Adsorption) may be used.

Further, as the ozone gas concentration, it is preferable to be not less than 30 g/Nm³ but not more than 2100 g/Nm³. Note that, in order to generate the ozone gas having a concentration of 400 g/Nm³, it is necessary to once store and condense an ozone gas. If the ozone gas concentration is less than 30 g/Nm³, the ozone-gas flow rate increases (the amount of ozone generation is a product of the ozone gas concentration and the ozone-gas flow rate, so that in order to obtain a same amount of ozone generation, the ozone-gas flow rate becomes higher as the ozone gas concentration becomes lower). Thus, it is unable to efficiently dissolve the ozone gas in the washing water. Meanwhile, if the ozone gas concentration becomes more than 2100 g/Nm³, the ozone generation efficiency of the ozone generator 4 is lowered. Namely, the power consumption per unit amount of ozone generation increases in comparison with the case in the range of not less than 30 g/Nm³ but not more than 2100 g/Nm³, and thus, this is not preferable.

Meanwhile, when the treated water (here, this means the membrane-filtered water) is used as the backwashing water, even though an organic substance or the like in the treated water will react with ozone, when the ozone gas concentration is set to 30 g/Nm³ or more, it is possible to make higher the ozone water concentration of the washing water. This is because the gas-to-liquid ratio can be made lower as the ozone gas concentration becomes higher, and the dissolution efficiency of the ozone gas becomes higher as the gas-to-liquid ratio becomes lower. In addition, the partial pressure of the ozone gas becomes higher as the ozone gas concentration becomes higher, so that, it is possible to make higher the ozone water concentration even if ozone is partially consumed by the reaction with the organic substance.

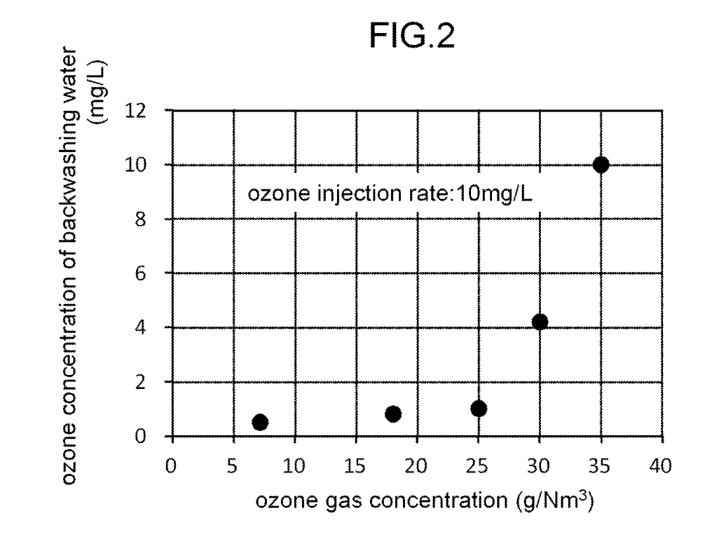

A change in the ozone water concentration relative to the ozone gas concentration in the case of the block diagram shown in FIG. 1, will be shown in FIG. 2. As shown in FIG. 2, when an ozone amount to be injected per 1 L of backwashing water, namely, an ozone injection rate, is set to 10 mg/L, the ozone water concentration of the backwashing water drastically increases at an ozone gas concentration of 30 g/Nm³ or more. The ozone water concentration at this time is 4 mg/L, and the gas-to-liquid ratio at the ozone gas concentration of 30 g/Nm³ becomes 10÷30=0.33. This is because the high concentration ozone gas is used, so that the ozone gas is supplied into the liquid even if ozone is consumed by the reaction with the organic substance in the treated water (membrane filtered water). This effect becomes larger when pressurized. Namely, at the ozone water concentration of 4 mg/L or more, a washing effect of the membrane is highly achieved. This is not limited to when the ozone injection rate is 20 mg/L.

When the ozone gas concentration is more increased, the gas-to-liquid ratios in the cases of the ozone gas concentration being set to 60 g/Nm³, 600 g/Nm³ and 2100 g/Nm³, are given as 0.17, 0.017 and 0.0048, respectively, so that the dissolution rate of the ozone gas becomes higher as the gas-to-liquid ratio becomes lower. Thus, and also because the ozone gas is dissolved according to Henry's law, the ozone water for backwashing with a higher concentration can be generated.

The washing effect is achieved due to oxidation power of ozone and due to shearing force by the washing water for breaking away the fouling substance adhered to the inside of the membrane, so that, as the ozone gas concentration becomes higher, the fouling substance is more likely broken away with a smaller ozone amount. Namely, because the fouling substance is oxidized by ozone, its adhesion to the membrane is reduced, so that it is likely broken away by the backwashing water. This is because the reaction is a second-order reaction that depends on the ozone water concentration and the concentration of fouling substance, and thus, as the ozone water concentration becomes higher, namely, as the ozone gas concentration becomes higher, the reaction between ozone and the fouling substance is more promoted. Furthermore, as long as the ozone amount (a product of the ozone water concentration and the backwashing water volume) is the same, with respect to an ozone gas concentration of 30 g/Nm³ or more, the higher the ozone water concentration, the more efficiently the reaction with the organic substance proceeds and thus the higher the recovery rate of the transmembrane pressure difference becomes. Thus, setting the ozone gas concentration to 30 g/Nm³ or more, makes possible more efficient backwashing.

The ozonated washing water goes through the switching valve 10 by way of the ozonated water pipe 14, and is then supplied to the membrane filtration-separation device 2 by way of the membrane connection pipe 11, so that washing of the membrane filtration-separation device 2 is started and the inside of the membrane is washed by the ozonated washing water. Furthermore, from the primary side of the membrane surface in the membrane filtration-separation device 2, ozone-containing bubbles 101 (hereinafter, abbreviated and referred to as ozone bubbles) each having a diameter of 0.1 μm to 1 mm emerge, so that the membrane surface is washed thereby. The ozone bubbles 101 cover the entire membrane surface. Note that in this case, at the time the ozonated washing water moves from the inside of the membrane to the primary side of the membrane, its pressures decreases, so that ozone having been dissolved in the water becomes unable to be dissolved therein and changes into an ozone gas. The reason why the ozone bubbles 101 cover the entire membrane surface is that the ozonated washing water exits to the primary side of the membrane through the entire membrane surface from the inside. By this reason, washing of the membrane is sufficiently executed.

When the backwashing process is completed after the elapse of a predetermined time period, for example, 20 minutes, the switching valve 10 is switched so that the filtered water pipe 12 and the membrane connection pipe are connected to each other, so that the membrane filtration treatment is started again in the above-described manner. Note that it is allowable to establish before switching, a standing-still time period without membrane filtration treatment. At this time, because the ozonated washing water is used as washing water, it is possible to handle and recover, as it is, the washing water remaining in the membrane connection pipe 11 also as the treated water, namely, to handle and recover, without disposal, the washing water remaining in the pipe, that is, the ozonated washing water, as the treated water filtered by the membrane.

Furthermore, it is also allowable not to inject the ozone gas into the ozone mixing tank 5 but to perform backwashing only using the treated water (membrane-filtered water). Instead, it is also allowable to provide a branch between the washing-water supply pump 8 and the ozone mixing tank 5 and to connect it to the ozonated water pipe 14, to thereby perform backwashing only using the treated water (membrane-filtered water).

When, for example, a sodium hypochlorite solution is used as washing water, it is required to be recovered separately as wastewater; however, this is not required when the ozonated washing water is used. This is because ozone is spontaneously decomposed as time goes by, and its half-life is 20 to 30 minutes. Furthermore, in this embodiment, when the ozone gas is injected into the pressurized washing water, this results in using the ozonated washing water having an ozone concentration higher than otherwise, so that backwashing can be completed in a shorter time in comparison with the conventional cases. As the washing water, tap water may be used, or the filtered water may be stored and then used.

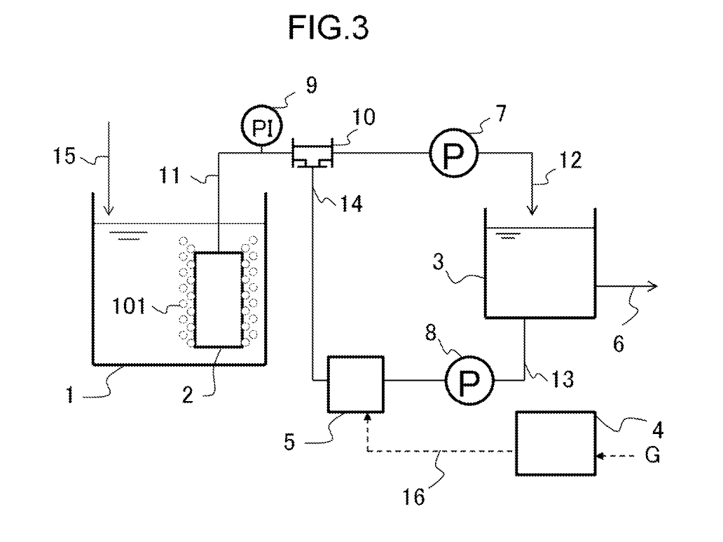

A block diagram in the case of using the filtered water is shown in FIG. 3. The configuration is the same as in FIG. 1 except that the filtered water pipe 12 and a treated water pipe 6 are connected to the washing water tank 3 and further, a pressure indicator 9 is set on the membrane connection pipe 11. Note that the pressure indicator 9 may be placed between the switching valve 10 and the filtration pump 7. Namely, the filtered water is stored in the washing water tank 3, so that the filtered water stored in the washing water tank 3 is used as washing water in the backwashing process. Furthermore, it is al so allowable that the pressure indicator 9 is placed on the membrane connection pipe 11, the pressure is constantly monitored using this pressure indicator 9 and, when it is elevated up to a specified pressure (a pressure predetermined at design time, for example, 5 to 100 kPa), the backwashing is started automatically. Using the filtered water makes it unnecessary to newly prepare washing water. Here, the pressure indicator 9 is preferable to have an ozone resistance characteristic. Note that, in each block diagram of aforementioned FIG. 1 and FIG. 3, a negative pressure filtration system is shown. This negative pressure filtration system is a system in which, upon application of a negative pressure, the water to be treated is suctioned to thereby obtain filtered water; whereas a press filtration system is a system in which water subject to filtration is pressed to pass through the membrane to thereby obtain filtered water. In the negative pressure filtration system, a suction pump for obtaining the filtered water is provided at the downstream side of the membrane module, and in the press filtering system, a pressure pump for pressing the water subject to filtration is provided at the upstream side of the membrane module.

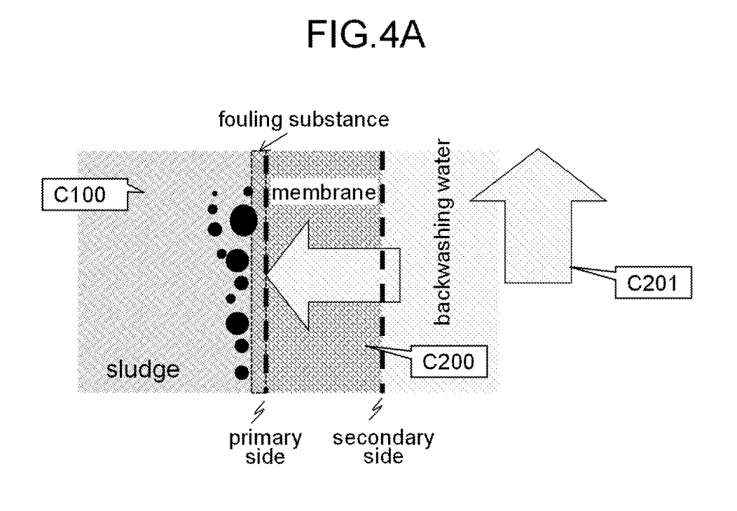

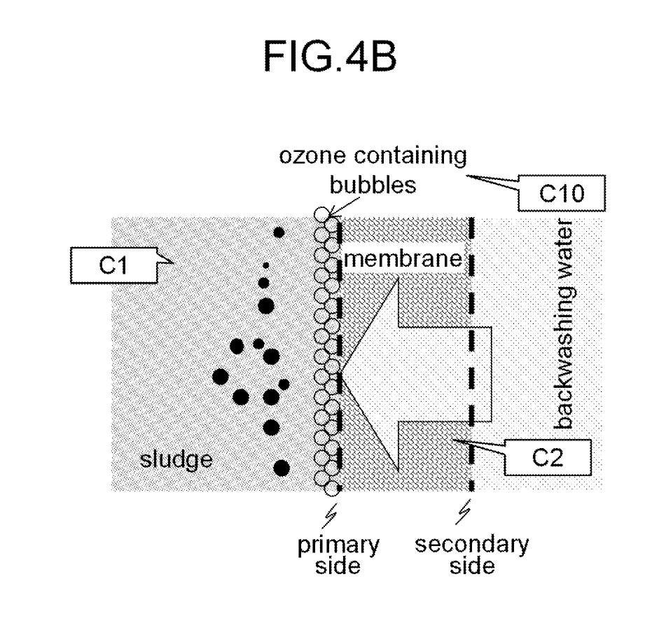

Description will be made about a situation at the time of backwashing the membrane filtration-separation device 2, using FIGS. 4A and 4B. According to the conventional methods, the amount of the backwashing water not entering the inside of the membrane is large (see, an arrow with the word balloon C201) and the ozone water concentration of the backwashing water is low, so that the reaction between the fouling substance in the membrane and ozone is insufficient, resulting in insufficient removal of the fouling substance (see, the portion at the word balloon C200), and thus the membrane can not be washed sufficiently. Furthermore, at the time the backwashing water reaches the primary side (sludge side) of the membrane, ozone has already been consumed, so that the fouling substance adhered to the primary side of the membrane surface can not be removed. In addition, no ozone-containing bubble emerges from the membrane surface, so that the sludge adhered to the primary side of the membrane surface can not be broken away, as well (see, the portion at the word balloon C100). In this regard, there is also a case where oxygen bubbles emerge; however, because of lack of oxidation power by oxygen, it is unable to remove/break away the respective fouling substance and sludge adhered to the primary side of the membrane surface.

In contrast, according to this embodiment, when the ozone gas is injected into the pressurized washing water, this results in supplying, as backwashing water, the ozonated washing water having an ozone concentration higher than otherwise, so that the backwashing water is all supplied to the membrane and the ozone water concentration is high, thus making possible sufficient removal of the fouling substance (see, the portion at the word balloon C2). Further, it is possible to cause the fouling substance in the membrane to react sufficiently with ozone, and to complete the reaction in a shorter time in comparison with the case of using, as washing water, low concentration ozone water generated by injecting an ozone gas into non-pressurized washing water, or a sodium hypochlorite aqueous solution. Furthermore, at the time the backwashing water reaches the primary side (sludge side) of the membrane, because it becomes free from the resistance of the membrane and reduced in pressure, the dissolved ozone changes into a gas (see, the portion at the word balloon C10), so that fine bubbles each having a diameter of 0.1 μm to 1 mm, emerge from an entire surface in the primary side of the membrane surface (in this case, there is no relation between what is the degree of reduction in the pressure and whether from the entire face or not).

As a result, the entire membrane surface can be washed in a uniform manner, because it is possible to cause the fouling substance in the primary side of the membrane surface to react efficiently with ozone, and a large quantity of the fine bubbles each having a diameter of 0.1 μm to 1 mm emerge from the entire surface in the primary side of the membrane surface. Namely, the bubbles of ozone slide up on the membrane surface, so that the removal of the fouling substance on the membrane surface is promoted (see, the portion at the word balloon C1). Here, “uniform” means that the number of bubbles that emerge per unit area of the membrane surface is uniform. The production amount of the bubbles is determined by a variation in the pressure, an ozone water concentration and a pore size of the membrane. Thus, when backwashing is performed in a state in which they are each kept the same, “uniform” is provided. Furthermore, due to the action of the ozone-containing bubbles, the fouling substance and the sludge in the primary side of the membrane surface can be broken away (see, the portion at the word balloon C1).

This makes it possible to keep clean the primary side of the membrane surface, and to ensure a design value of flux that is higher in comparison with the case of using, as washing water, low concentration ozone water or a sodium hypochlorite aqueous solution. Namely, it is possible to achieve the flux that satisfies the design value for a long period of several hours to several hundreds of days. This effect can not be achieved solely by aerating the membrane surface with an ozone gas because the membrane surface vibrates up and down and right and left, so that the ozone gas does not uniformly hit the membrane surface. Further, if the membrane surface is aerated with an ozone gas, the inside of the membrane can not be washed, and thus, likewise, this effect can not be achieved. Note that in FIGS. 4A and 4B, in order to clarify the difference between the conventional example and this embodiment, the oxygen gas that emerges in the primary side is not demonstrated.

Further, because the ozone consumed by such a reaction becomes oxygen, in the case of application to a membrane bioreactor method (hereinafter, abbreviated as MBR (Membrane Bioreactor)), the oxygen is supplied to the sludge. Thus, the activity of the sludge becomes higher in comparison with the case of using as washing water, low concentration ozone water generated by injecting an ozone gas into non-pressurized washing water, or a sodium hypochlorite aqueous solution, and also the required aeration amount can be reduced. Furthermore, because the ozone used in the backwashing is partly supplied to the tank for water to be treated 1 to thereby react with the sludge, it is al so possible to suppress the growth of sludge to thereby reduce the volume of an excessive sludge, and further to prevent the generation of the excessive sludge.

Note that, at the time of backwashing, when bubbles are supplied by a blower, an air pump or the like, in a direction from below the membrane filtration-separation device 2 (in a direction from just beneath the membrane filtration-separation device 2), a shearing force against the flow direction of the membrane-filtered water can be applied to the primary side of the membrane surface, so that a washing effect is achieved that is higher in comparison with the case of not supplying the bubbles by the blower, the air pump or the like. Furthermore, when bubbles each having a diameter of several mm to several cm and bubbles each having a diameter of several μm to 1 mm, are mixed and then supplied, a stronger shearing force can be applied in comparison with the case of not supplying the bubbles by the blower, the air pump or the like, so that a washing effect is achieved that is much higher in comparison with the case of not supplying the bubbles by the blower, the air pump or the like.

As the ozone mixing tank 5, it is preferable to use a reactor of an ejector or injector type. Further, a mechanism for promoting gas-liquid mixing, such as a static mixer, etc., may be placed at the downstream side of such a reactor and at the upstream side of the switching valve 10, specifically, in the ozonated water pipe 14. Because of these, the ozone gas is promoted to be micronized, so that, with respect to the ozone gas, the dissolution of ozone into the backwashing water is promoted. Meanwhile, even when the ozone water is stored in the ozone mixing tank 5 and the washing-water supply pump 8 is placed between the switching valve 10 and the ozone mixing tank 5, the fouling substance in the membrane filtration-separation device 2 can be removed by the ozonated washing water. In this case, however, the washing-water supply pump 8 is required to have a specification of ozone resistance characteristic.

Furthermore, it is better that the ozone gas concentration applied to the ozone generator 4 be as high as 30 g/Nm³ or more. At the time of generating the ozonated washing water from the washing water, when the ozone gas concentration is set to 30 g/Nm³ or more, it is possible to generate the ozonated washing water whose concentration is higher than a concentration of the ozone water generated at the ozone gas concentration of less than 30 g/Nm³. Further, when the ratio of the ozone-gas flow rate to the washing water flow rate (hereinafter, referred to as a gas-to-liquid ratio) is set smaller than a gas-to-liquid ratio for the ozone gas concentration of less than 30 g/Nm³, to thereby make the dissolution rate of ozone higher than that at the gas-to-liquid ratio for the ozone gas concentration of less than 30 g/Nm³, it is possible, using the pressure from the washing-water supply pump 8, not to emit a waste ozone gas, or almost not to emit it in comparison with the amount of the waste ozone gas in the case where the ozone gas concentration is less than 30 g/Nm3. This makes it possible to efficiently use the ozone gas.

It suffices that the pressure for supplying the ozonated washing water as washing water is given as 10 to 500 kPa; more preferably, 20 to 400 kPa; and much more preferably, 30 to 300 kPa. If the pressure is too high, there is a possibility that it exceeds the withstanding pressure of the membrane filtration-separation device. Meanwhile, if the pressure is low, the dissolution of the ozone gas becomes insufficient resulting in reduction of the ozone water concentration, or an ozone gas unable to be dissolved partly accumulates in the pipe. Further, such a pressure may be set to an arbitrary value by adjusting the flow rate of the ozonated washing water.

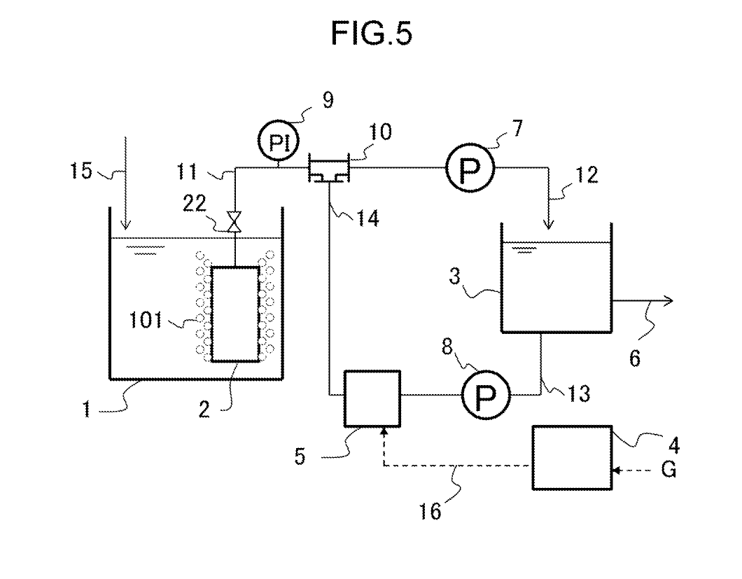

In this regard, at the time of backwashing, if only the treated water (membrane-filtered water) is initially supplied to the membrane filtration-separation device 2 without injection of the ozone gas, and at the time the pressure becomes higher than a given value (for example, 25 kPa), the ozone gas is injected to be dissolved, followed by washing the membrane filtration-separation device 2, it is possible to execute the washing more efficiently. Namely, there is no occurrence of generating under a low pressure (for example, 10 kPa) washing water not containing the dissolved ozone gas, so that a washing effect of the membrane can be highly maintained. This can be achieved by placing a pressure adjusting valve 22 on the membrane connection pipe 11 as shown in FIG. 5. The pressure adjusting valve 22 is preferable to have an ozone resistance characteristic.

It suffices that the flow rate for supplying the washing water is set to 1/10 to 10 times the filtered water volume. The filtered water volume can be calculated from the flux and the area of the membrane. Namely, the value obtained by multiplying the flux by the area of the membrane is the filtered water volume. If the flow rate for supplying the washing water is less than 1/10 times, the transmembrane pressure difference does not decrease resulting in insufficient washing effect, and thus this is not preferable. Meanwhile, if the flow rate for supplying the washing water is larger than 10 times, the usage of ozone increases, and also the filtered water volume is reduced, and thus this is not preferable.

It suffices to set the backwashing time to be not shorter than 10 seconds but not longer than 60 minutes. If the backwashing time is shorter than 10 seconds, backwashing becomes insufficient, whereas if it is longer than 60 minutes, the usage of ozone increases. At the same time, if the backwashing time is set too long, it is unable to execute the filtration treatment for the corresponding time, so that the filtered water volume is reduced, and thus this is not preferable. However, when a specified value of the flux at design time, for example 0.2 to 5.0 m³/day, can be ensured, the time is not limited to the above, and may be set within the time range where the flux at design time is ensured. Further, at the time of backwashing, the ozone water, after being flowed for a specific time, may be retained as it is. It suffices to also set the retention time to be not shorter than 10 seconds but not longer than 60 minutes as described above, and further, when the above flux at design time can be ensured, the time may be set within the time range where the flux at design time is ensured.

As the material of the membrane to be used as the membrane filtration-separation device 2, it is required to have an ozone resistance characteristic, and thus, it is preferable to use a fluorine-based resin compound, such as a copolymer of tetrafluoroethylene and perfluoroethylene-alkyl vinyl ether (PFA), poly-vinylidene fluoride (PVDF), polytetrafluoroethylene (PTFE), a copolymer of tetrafluoroethylene and ethylene (ETFE), or the like.

Furthermore, among the membranes having such ozone resistance characteristics, a microfiltration membrane (hereinafter, referred to as MF (Micro Filtration) membrane), or an ultrafiltration membrane (hereinafter, referred to as UF (Ultra Filtration) membrane) may be used. Further, other than the membrane, equipment to be in contact with ozone is also required to have an ozone resistance characteristic. It suffices that the average pore size of the membrane is given as 0.001 to 1 μm, more preferably, 0.01 to 0.8 μm. If the average pore size is smaller than this, clogging of the membrane occurs in a short time, and in addition, the pressure at the membrane filtration increases, and thus this is not preferable. Meanwhile, if the average pore size is larger than this, the membrane filtration ability decreases, so that the filtered water is degraded in SS (Suspended Solids) (the value of SS increases) to make the membrane more easily clogged, and thus this is not preferable. The membrane filtration-separation device 2 is provided with a module structure in which such a membrane is stored (an assembled structure in which, in order to allow the membrane to filter water, the pipe and the like are attached thereto).

As the shape of the membrane in the membrane filtration-separation device 2, any given shape of, such as, a hollow fiber type (dip type, casing type), a flat membrane type (dip-type flat membrane shape, casing-type spiral shape), a monolith type, or the like, may be applied. Furthermore, the filtration system may be either a total-amount filtration system or a cross-flow filtration system. Further, although a negative pressure filtration system is shown each in the block diagrams of FIG. 1 and FIG. 3, it may be a press filtration system.

Examples of water of the type subject to membrane filtration in this embodiment include clean water, industrial water, sewage, sewage secondary effluent, plant wastewater, seawater, human waste and the like, and water produced during processing for the treatment of any of the above. Further, its biological treatment may be executed in combination with an anaerobic treatment, an anoxic treatment or an aerobic treatment. This invention can be applied to any of the cases: where, like MBR, the above water of the type and the sludge are input to the tank for water to be treated 1 and mixed/treated therein, and the-thus treated water is separated into sludge and treated water using the membrane filtration-separation device 2; where the membrane filtration treatment is directly applied to the above water of the type subject to membrane filtration; and where the membrane filtration is performed without input of the sludge to the tank for water to be treated 1. In any of the cases, when an inorganic or organic coagulant is applied to the tank for water to be treated 1, such an effect is achieved that the flux of the membrane filtration treatment is enhanced or the membrane becomes unlikely to be clogged.

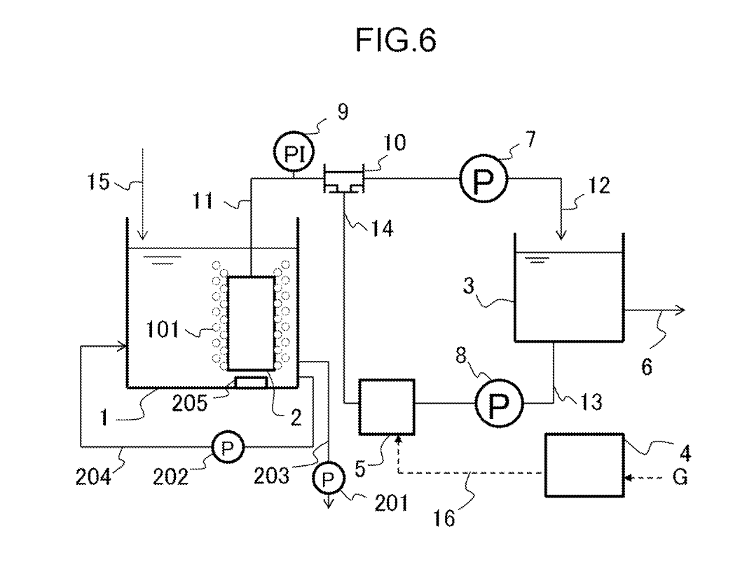

FIG. 6 is a block diagram showing a case where sewage or plant wastewater is treated by MBR. In contrast to FIG. 3, components are added as follows. An excessive-sludge withdrawing pump 201 is connected through an excessive-sludge withdrawing pipe 203 to the tank for water to be treated 1. Further, a sludge circulating pump 202 is connected through a sludge circulating pipe 204 to the tank for water to be treated 1. The sludge circulating pump 202 is, however, not essential. Furthermore, an air diffuser 205 is placed in the tank for water to be treated 1 at a portion beneath the membrane filtration-separation device 2 (said portion means a place in the tank for water to be treated 1 and close to the bottom face of the tank for water to be treated 1).

Next, operations will be described. In the tank for water to be treated 1, the activated sludge having an MLSS (Mixed Liquor Suspended Solid) concentration of 3000 to 20000 mg/L is filled. In the tank for water to be treated 1, removal of organic substance is executed by the activated sludge, followed by separation into the activated sludge and the treated water through the membrane filtration-separation device 2. The activated sludge is circulated by the sludge circulating pump 202.

Furthermore, the increased activated sludge is withdrawn by the excessive-sludge withdrawing pump 201, so that the MLSS concentration in the tank for water to be treated 1 is kept constant. By the air diffuser 205, air is supplied to the activated sludge in the tank for water to be treated 1 and the membrane surface of the membrane filtration-separation device 2 is vibrated by air, so that the treatment of the membrane is executed in a stable manner (here, stable means that the flux of the value as designed is achieved for a long period (a period of several tens of days to several hundreds of days)). Although a blower is connected to the air diffuser 205, it is not shown here. In this device, when backwashing by the above-described ozonated washing water is periodically executed, it is possible to obtain the flux that is higher in comparison with the case of using, as washing water, low concentration ozone water generated by injecting an ozone gas into non-pressurized washing water, or a sodium hypochlorite aqueous solution.

Note that as a type of MBR, there is shown a case where the membrane filtration-separation device 2 is dipped in the tank for water to be treated 1, in each of FIG. 1, FIG. 3 and FIG. 5; however, this is not limitative, and it is also allowable to divide the tank for water to be treated 1 into plural tanks, to place the membrane filtration-separation device 2 in the tank at the downstream side, and to circulate the activated sludge in the upstream side and the downstream side using a pump. Further, it is also allowable to place the membrane filtration-separation device 2 out of the tank for water to be treated 1 and to supply using a pump, the activated sludge in the tank for water to be treated 1 to the membrane filtration-separation device 2 so as to be circulated. Further, it is also allowable to divide the inside of the tank for water to be treated 1 into two portions, to employ the upstream-side portion as an anaerobic tank and the downstream-side portion as an aerobic tank, and to dip the membrane filtration-separation device 2 in the aerobic tank. Furthermore, it is also allowable to divide the inside of the tank for water to be treated 1 into three portions, to employ them as an anoxic tank, an anaerobic tank and an aerobic tank, respectively, in an order from the upstream side, and to dip the membrane filtration-separation device 2 in the aerobic tank.

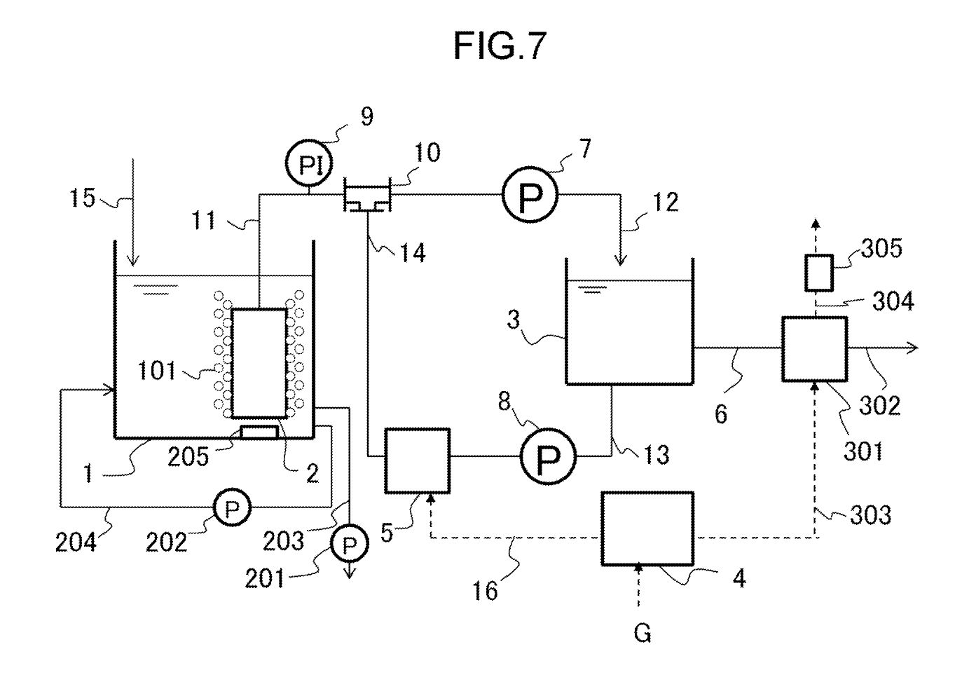

FIG. 7 is a block diagram in the case with respect to FIG. 6 where the filtered water is subjected to an ozone treatment. Namely, in order to improve the water quality of the filtered water, the chromaticity and the turbidity of the filtered water are improved by using oxidation power of ozone, and an organic substance, an inorganic substance, such as iron, manganese, and an virus, etc. are removed. In contrast to FIG. 6, components are added as follows. An ozone-treated water pipe 302 is connected through an ozone reaction tank 301 to the treated water pipe 6. Further, the ozone reaction tank 301 is connected to the ozone generator 4 through an ozone gas pipe for treated water 303 for mixing ozone with the treated water. Further, waste ozone-gas treatment equipment for treated water 305 by which an ozone gas emitted from the treated water is subjected to exhaust treatment, is connected to the ozone reaction tank 301 through a waste ozone-gas pipe for treated water 304 for exhausting the ozone gas.

Next, operations will be described. The filtered water stored in the washing water tank 3 is sent to the ozone reaction tank 301 through the treated water pipe 6. The filtered water is subjected to the ozone treatment in such a manner that the ozone gas generated by the ozone generator 4 is supplied to the ozone reaction tank 301 through the ozone gas pipe for treated water 303 for mixing ozone with the treated water. Through the waste ozone-gas pipe for treated water 304 for exhausting the ozone gas, the undissolved ozone gas is decomposed into oxygen by the waste ozone-gas treatment equipment for treated water 305 by which an ozone gas emitted from the treated water is subjected to exhaust treatment, so that it is rendered harmless and released into the atmosphere. The ozone treated water is used as recycling water, etc. through the ozone-treated water pipe 302. Because the ozone generator 4 for generating the ozonated washing water for backwashing is employed for the ozone treatment of the filtered water, it is possible to use the ozone generator more efficiently, and to more improve the water quality of the filtered water.

Furthermore, in the case of intermittently execute backwashing of the membrane filtration-separation device 2 (getting on once per day to several weeks or several months) and using the aforementioned ozonated washing water as the backwashing water, the reaction of ozone with the fouling substance is completed in a short time of not less than 10 seconds but not more than 60 minutes, and further the backwashing water is not necessary to be recovered as wastewater; this makes it possible to effectively employ the ozone generator 4 at the time of treating the filtered water by ozone. Further, in the case of using ozone at the time of backwashing, the treated water flowing in through the treated water pipe 6 is stored in the ozone reaction tank 301, and after the completion of backwashing, the ozone treatment is started in the ozone reaction tank 301, and then the water is caused to flow out as the ozone treated water through the ozone-treated water pipe 302.

Note that it is also allowable that, as depending on the intended use of the treated water, in the case, for example, where the ozone treatment is executed to the extent corresponding to the required amount of the high quality treated water and thus the ozone treatment is otherwise not executed, a part of the filtered water is treated by ozone and the other part is not treated by ozone. Meanwhile, this type of embodiment is not limited to MBR, and can be implemented with any method so far as it is a combination of membrane filtration treatment and ozone treatment.

### Embodiment 2

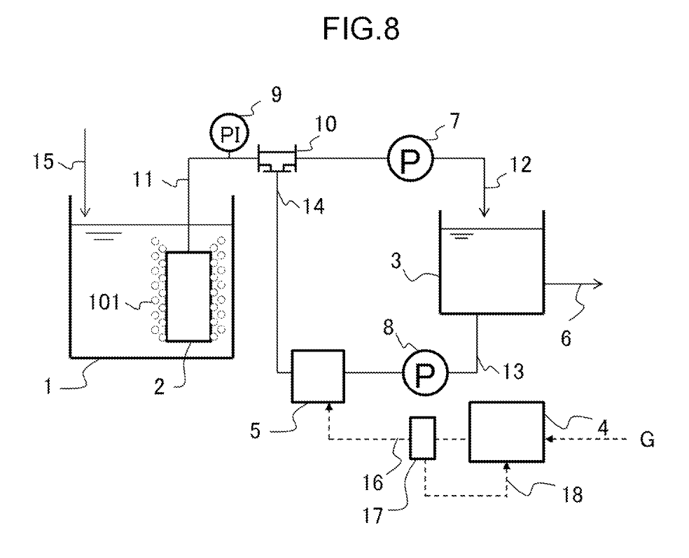

FIG. 8 is a block diagram showing an example in Embodiment 2 of the invention. In contrast to FIG. 3, components are added as follows. An ozone-gas storage tank 17 capable of storing an ozone gas is placed between the ozone generator 4 and the ozone mixing tank 5 through the ozone gas pipe 16. Further, the ozone-gas storage tank 17 and the ozone generator 4 are connected to each other through an oxygen gas pipe 18.

Next, operations will be described. At the time of backwashing, the ozone gas generated by the ozone generator 4 using an oxygen gas as a source material is sent to the ozone-gas storage tank 17 through the ozone gas pipe 16, and stored in the ozone-gas storage tank 17 as being adsorbed in an adsorbent, such as silica gel, at a low temperature. In the figure, as indicated by a sign G, although an oxygen-containing gas is supplied to the ozone generator 4, it is more preferable in this case that an oxygen gas generated from liquid oxygen be supplied instead of the oxygen-containing gas. Note that, an oxygen gas included in the ozone gas and not adsorbed in the silica gel, returns to the ozone generator 4 through the oxygen gas pipe 18, and is then used again as a source material of an ozone gas.

At the time of backwashing, supplying the ozone gas from the ozone gas generator 4 to the ozone-gas storage tank 17 is suspended, and in addition, the return pathway from the ozone-gas storage tank 17 to the ozone generator 4 is interrupted. An injector-type reactor is employed as the ozone mixing tank 5; using a negative pressure produced by this reactor, the ozone gas stored in the ozone-gas storage tank 17 is sucked; the sucked ozone gas is dissolved in the washing water to generate the ozonated washing water; and then, backwashing of the membrane filtration-separation device 2 is executed. Instead, in order to take out the stored ozone gas more efficiently, the ozone gas in the ozone-gas storage tank 17 may be sucked using a pump so that the ozone gas is sent to the ozone mixing tank 5.

Thereafter, only oxygen is supplied to the ozone-gas storage tank 17 from the ozone generator 4, to thereby promote sucking of the ozone gas in the ozone-gas storage tank 17. After the completion of backwashing, the ozone gas is supplied again from the ozone gas generator 4 to the ozone-gas storage tank 17 to thereby adsorb the ozone gas into an adsorbent, such as silica gel, at a low temperature of −30° C. to −90° C.

When the stored ozone gas is used, this makes it possible to use an ozone gas having a concentration higher in comparison with the case where the ozone gas is not stored or condensed, so that it is possible to reduce the gas flow rate required for generating the ozonated washing water, and thus to enhance the dissolution efficiency of the ozone gas in comparison with the case where the ozone gas is not stored or condensed.

Further, because backwashing is intermittently executed, when the ozone gas is generated and stored using the ozone generator 4 during off-peak night hours, and then the ozonated washing water is generated using the stored ozone at the time of backwashing, it is possible to achieve more power saving.

Further, the ozone gas may be stored continuously during a time period for the membrane filtration treatment other than that for backwashing. This allows to employ the ozone generator with a smaller amount of ozone generation in comparison with the case where the ozone gas from the ozone generator is not stored or condensed, thus making it possible to downsize the apparatus. Note that, as oxygen used in this embodiment, it is preferable to use high purity oxygen in which nitrogen or the like is not contained as much as possible, and, for example, an oxygen gas vaporized from liquid oxygen may be suitably used.

Further, at the time of releasing the ozone gas adsorbed in the ozone-gas storage tank 17, when an oxygen gas discharged from the ozone-gas storage tank 17 at an initial stage for that releasing (a stage at which oxygen firstly emerges) is recovered, it becomes possible to take out the ozone gas of a higher concentration. The concentration of the ozone gas is preferably from 15 wt % (226 g/m³) to 100 wt % (2,143 g/m³). More preferably, it is from 25 wt % (390 g/m³) to 99 wt % (2,111 g/m³). On this occasion, with the placement of a pump on the ozone gas pipe 16, the ozone gas stored in the ozone-gas storage tank 17 may also be drawn out using the pump.

In the case of injecting a specific amount of ozone gas, as the ozone gas concentration becomes higher, the ozone-gas flow rate relative to the washing water flow rate can be set smaller and further, the amount of oxygen contained in the ozone gas becomes smaller; as a result, the ozone gas can be dissolved in the washing water more efficiently.

Further, in order to measure the ozone water concentration of the ozone-containing washing water, it is also allowable to place an ozone concentration monitor on the membrane connection pipe 11 or the ozonated water pipe 14. Instead, it is also allowable to provide a bypass line to the membrane connection pipe 11 or the ozonated water pipe 14, and to place the ozone concentration monitor on that line. In this case, the ozone water that passed the ozone concentration monitor is returned to the membrane connection pipe 11 or the ozonated water pipe 14.

Furthermore, the ozone gas concentration may be controlled based on the value of the ozone concentration monitor. Namely, the ozone water concentration varies depends on the water quality of the treated water (membrane-filtered water) to be used as washing water, and thus, if the value of the ozone concentration monitor is lower than a specified value, for example, 3 mg/L, the ozone gas concentration is increased. This makes it possible to efficiently generate and use ozone while keeping sufficient washing ability.

Furthermore, when the ozone-gas storage tank 17 is provided as dual systems, the ozone gas stored in the ozone-gas storage tank 17 can be taken out in an alternate manner, so that it becomes possible to take out a high concentration ozone gas more stably, namely, under the state in which a variation in ozone gas concentration is smaller, than in the case of the single system.

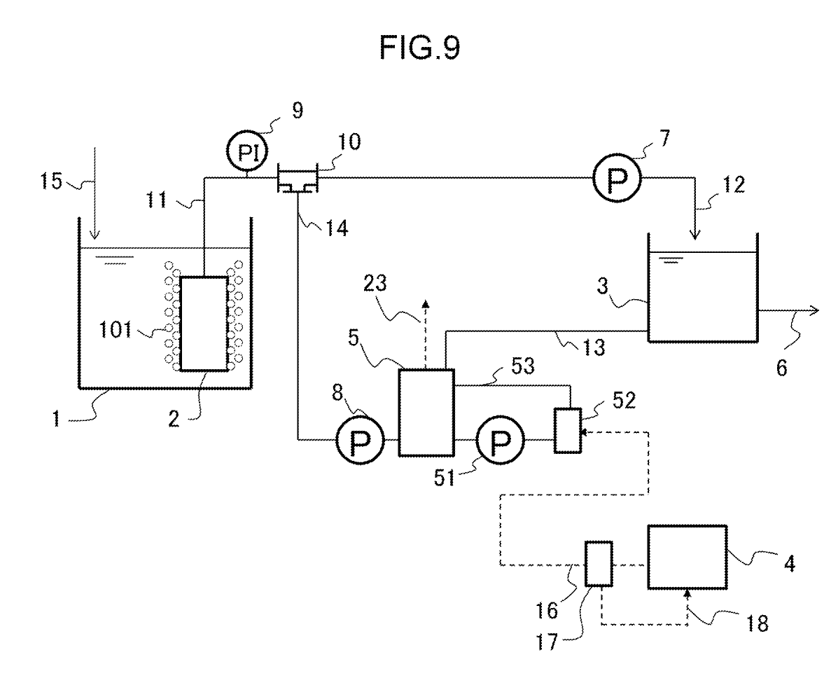

Moreover, using FIG. 9, a case is described in which an ejector 52 is provided to the ozone mixing tank 5, and also an ozone water circulating pump 51 for sending the zone water to the ejector is provided, and they are connected to each other by means of an ozone water circulating pipe 53. In this case, the washing-water supply pump 8 is placed on the ozonated water pipe 14. With respect to the washing-water supply pump 8 and the ozone water circulating pump 51 in this case, the material of each of their liquid-contact portions is required to have an ozone resistance characteristic. Further, to the upper side of the ozone mixing tank 5, a waste ozone-gas pipe 23 for exhausting an ozone gas undissolved in the water is connected.

Next, operations will be described. From the washing water tank 3, the washing water is supplied due to, for example, gravity drop or the like, to the ozone mixing tank 5. The washing water in the ozone mixing tank 5 is supplied using the ozone water circulating pump 51 to the ejector 52, and at this time, by use of a negative pressure produced in the ejector 52, a condensed ozone gas of a high concentration is sucked into the ejector 52 from the ozone-gas storage tank 17, so that the washing water and the ozone gas are mixed together in the ejector 52. Note that it is also allowable to provide an unshown pump on the ozone gas pipe 16 between the ejector 52 and the ozone-gas storage tank 17, to thereby supply the ozone gas using the pump. When the washing water and the ozone gas are mixed together, high concentration ozone water is generated, which is then injected into the ozone mixing tank 5 through the ozone water circulating pipe 53. This series of operations are continued to be repeated until a below-described specified concentration is reached, so that the ozone concentration in the washing water in the ozone mixing tank is made higher.

Using, though not shown in the figure, an ozone concentration monitor placed, for example, on the ozone water circulating pipe 53, the ozone water measured to have the specified concentration, for example, a concentration of 10 mg/L is prepared as washing water, and then, at the timing of backwashing, using the washing-water supply pump 8, the high concentration ozone water is supplied to the membrane filtration-separation device 2 through the ozonated water pipe 14, to thereby execute backwashing. The ozone gas that is undissolved in the ozone mixing tank and that passes the waste ozone-gas pipe, is then decomposed by a catalyst into harmless oxygen and released into the atmosphere. Instead, it is also allowable not to decompose the waste ozone gas but to inject it into the tank for water to be treated 1 or the washing water tank 3.

As described above, because the condensed ozone gas is used, it is possible to generate sufficiently-high concentration ozone water, namely, high concentration ozone water having a concentration of 3 mg/L or more, for example, so that the membrane can be washed efficiently by using this water. Note that the ozone gas stored in the ozone-gas storage tank 17 may be taken out using a pump without passing through the ejector 52 and then supplied while being bubbled through a diffuser or the like from the under side of the ozone mixing tank 5. Even in this case, an effect similar to the above is achieved.

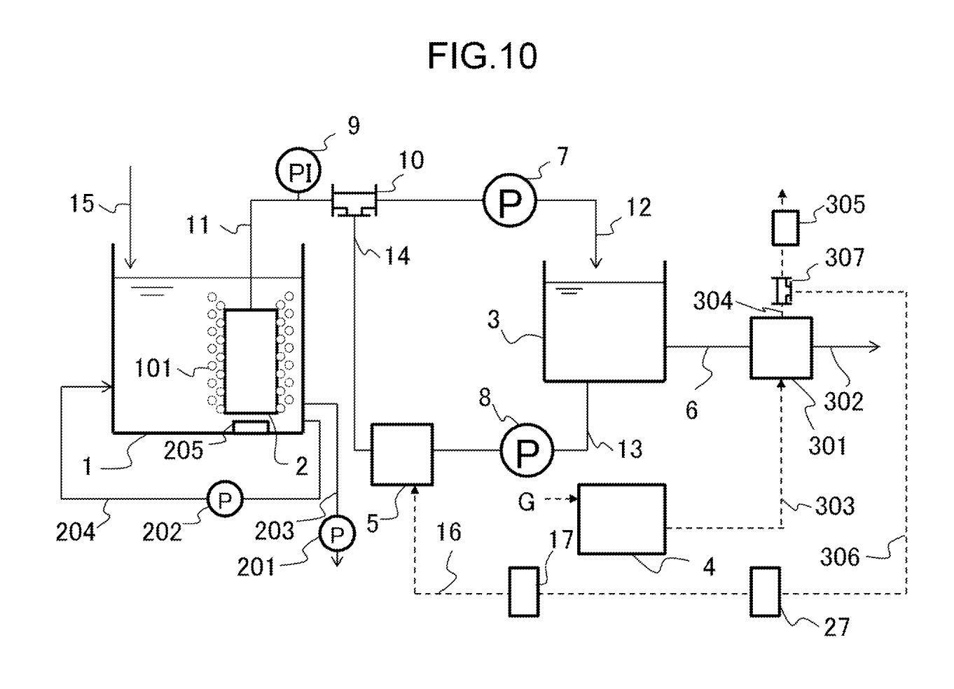

FIG. 10 is a block diagram in the case with respect to FIG. 8 where, using the waste ozone gas exhausted from the ozone reaction tank 301, the ozonated washing water for backwashing is generated. In contrast to FIG. 8, components are added as follows. A waste ozone-gas switching valve 307 is placed on the waste ozone-gas pipe for treated water 304 and is connected through a waste ozone-gas recycling pipe 306 to the ozone gas mixing tank 5. Further, the ozone-gas storage tank 17 is placed on the waste ozone-gas recycling pipe 306.

Next, operations will be described. While the ozone treatment of the filtered water in the ozone reaction tank 301 is executed continuously, the waste ozone-gas treatment in the waste ozone-gas treatment equipment for treated water 305 is also continuously executed, correspondingly. Here, in order to recover the ozone gas required for backwashing, the waste ozone-gas switching valve 307 is switched so that a waste ozone gas is introduced into the ozone-gas storage tank 17, during a period for storing the required amount of ozone, to thereby store the ozone gas. In this case, if a mechanism for removing moisture contained in the waste ozone gas is placed, namely, a dehumidifier 27 is placed, the ozone gas can be stored efficiently. When backwashing of the membrane filtration-separation device 2 is started, the ozonated washing water for backwashing is generated in such a manner that the stored ozone gas is exhausted and introduced into the ozone mixing tank 5.

When storing of the ozone gas is completed, the waste ozone-gas switching valve 307 is switched so as to allow the waste ozone-gas treatment equipment for treated water 305 to treat the waste ozone gas exhausted from the ozone reaction tank 301. This makes it possible to efficiently use ozone while recycling the waste ozone gas.

Furthermore, when an injector-type reactor is employed as the ozone mixing tank 5, it is possible to draw the waste ozone gas therein and to efficiently dissolve the ozone gas into the washing water, to thereby generate the ozonated washing water. Note that, this embodiment is not limited to MBR, and can be implemented with any method so far as it is a combination of membrane filtration treatment and ozone treatment.

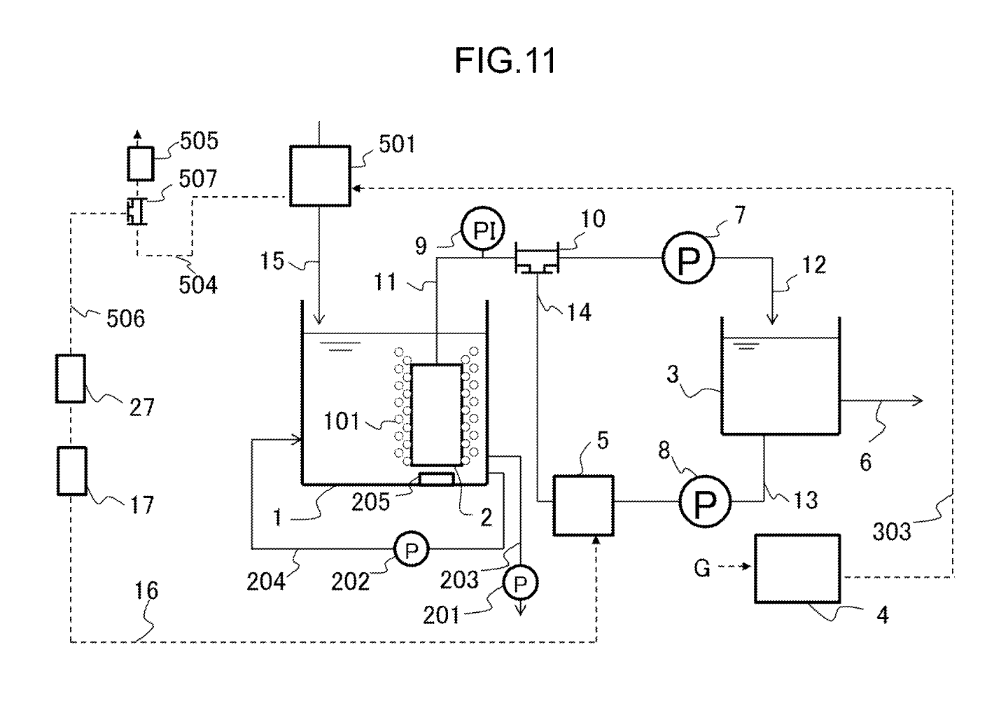

FIG. 11 is a block diagram in the case where the water to be treated before entering the tank for water to be treated 1 is subjected to pre-ozone treatment, and the ozonated washing water for the backwashing is generated using the waste ozone gas exhausted from an ozone reaction tank 501. The other configuration and operations are the same as those in FIG. 10. By applying the pre-ozone treatment, a recalcitrant (hardly decomposable) organic substance that can not removed by MBR contained in the water to be treated, namely, microorganisms, is modified by the ozone treatment so that it is reduced in molecular weight and thus can be removed by microorganisms. This enhances the MBR-treated water quality. Note that, when the water to be treated containing aerobic microorganisms is filtered in a membrane bioreactor method or the like, oxygen exists in the bubbles of the waste ozone gas, and the bubble size is being decreased (a diameter of 0.1 μm to 1 mm), so that the area of gas-liquid interface is being increased. As a result, with respect to the oxygen amount of the same volume, the efficiency of dissolution into the water to be treated becomes higher to the extent corresponding to an increase in the area of gas-liquid interface due to decrease in the bubble size, so that when the ozone gas is injected while being pressurized into the washing water, it is possible to make the activity of the microorganisms higher than otherwise.

### Embodiment 3

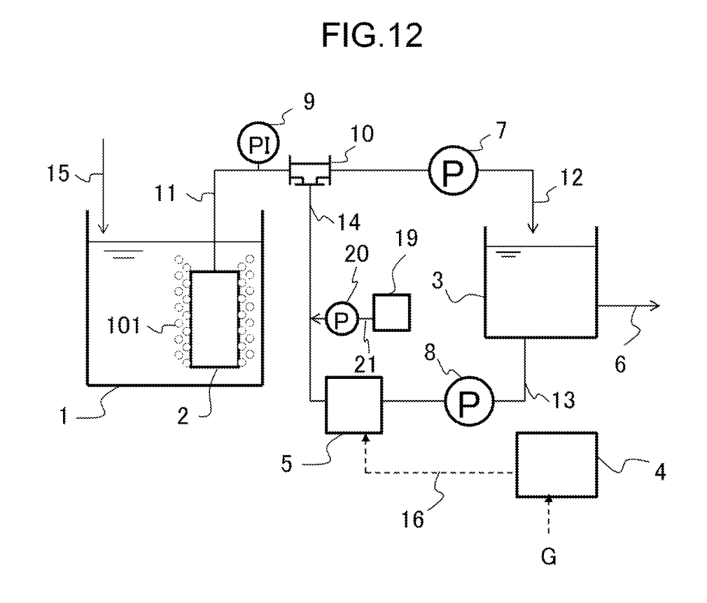

FIG. 12 is a block diagram showing an example in Embodiment 3 of the invention. In contrast to FIG. 3, components are added as follows. An acid storage tank 19 is connected through an acid supply pipe 21 to the ozonated water pipe 14. In addition, an acid supply pump 20 is placed on the acid supply pipe 21 between the acid storage tank 19 and the ozonated water pipe 14.

Next, operations will be described. At the time of backwashing, when the ozonated washing water is supplied to the membrane filtration-separation device 2, in accordance therewith, an acid in the acid storage tank 19 is supplied using the acid supply pump 20 to the ozonated washing water in the ozonated water pipe 14 through the acid supply pipe 21, so that acidic ozonated washing water is generated and the membrane filtration-separation device 2 is backwashed thereby. It is also allowable to place a static mixer, etc. downstream of a point where the acid is injected in the ozonated water pipe 14, to thereby enhance the miscibility of the acid and the ozonated washing water, namely, to enhance the dissolution degree of ozone and thus to make the dissolved ozone concentration higher.

As the acid, an inorganic acid, such as hydrochloric acid, sulfuric acid, nitric acid or the like, or an organic acid, such as oxalic acid, citric acid or the like, may be used. Using such an acid makes it possible to enhance the removal effect of a metal, such as iron, calcium, magnesium, silicon, aluminum or the like, that is adhered to the inside of the membrane or the membrane surface and that forms a so-called scale (“scale” means a sediment consisting mainly of inorganic substances).

The timing of injecting the acid may be set before or after the ozonated washing water is supplied as backwashing water to the membrane filtration-separation device 2, or may be set at the same time. Namely, it is allowable to execute any of embodiments: in which washing is performed by injecting the acid and thereafter, washing is performed by the ozonated washing water; in which the acid is added beforehand to the ozonated washing water and washing is performed by that water; and in which washing is performed by the ozonated washing water and thereafter, washing is performed by injecting the acid. Further, before washing is performed using the acid, the washing water (membrane filtered water) into which the ozone gas is not injected, may be used in advance.

Note that, in the case where the acid is used in combination, when switching is made from backwashing to membrane-filtration treatment, it is required to once recover the washing water remaining in the membrane filtration-separation device 2 or the membrane connection pipe 11. This is because the acid does not satisfy a PH range as the wastewater standard or effluent standard. When an inorganic acid is used as the acid, the water is usable as the treated water after execution of a PH adjustment, only. When an organic acid is used as the acid, it is better to return the water to the tank for water to be treated 1. However, if, due to dilution, the amount of used organic acid is at a level that satisfies the wastewater standard or effluent standard, it is also allowable, as the dilution effect, not to return the water to the tank for water to be treated 1 but to recover it as the treated water.

### Embodiment 4

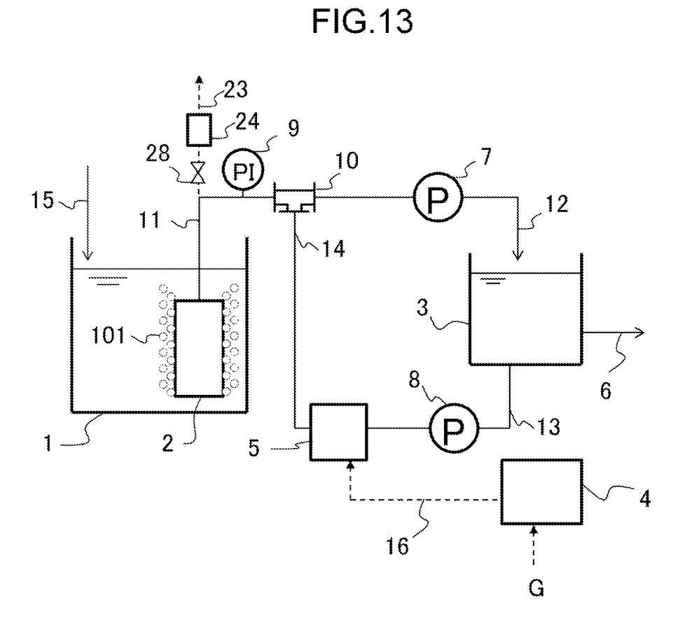

FIG. 13 is a block diagram showing an example in Embodiment 4 of the invention. In contrast to FIG. 3, components are added as follows. A waste ozone-gas pipe 23 is connected to the membrane connection pipe 11, and a pressure relief valve 28 and waste ozone-gas treatment equipment 24 are serially placed by way of the waste ozone-gas pipe 23.

Next, operations will be described. At the time of backwashing, because the ozone gas of a high concentration of 30 g/Nm³ or more is used, when the ozone gas is injected into the pressurized ozone gas, it is possible to dissolve the ozone gas in the washing water more efficiently than otherwise; however, undissolved ozone gas or oxygen remains in the ozonated washing water, so that, when the pressure measured by the pressure indicator 9 exceeds a specified value, for example, 50 kPa, at the time of backwashing, the pressure relief valve 28 opens to take said ozone gas or oxygen out, and then when the pressure decreases to a specified value, for example, 20 kPa, the pressure relief valve 28 closes. Namely, it works at intervals as a vent.

According to the waste ozone treatment apparatus described in Patent Document 1, it is always placed in an open state, and no inner-pressure control is applied to the backwashing water tank 30 for generating ozonated washing water. Thus, the waste ozone-gas treatment equipment 24 in this embodiment differs to the waste ozone treatment apparatus described in Patent Document 1.

The pressure relief valve 28 may be set with an open time and a closing time, so that opening and closing of the valve is automatically adjusted. Instead, it may be controlled using the value of the pressure indicator 9. Upper and lower limits of the pressure are set, and when the pressure reaches the upper limit, the pressure relief valve 28 is made open, and when it reaches the lower limit, the pressure relief valve 28 is closed. Instead, as the pressure relief valve 28, a valve, such as a safety valve, that has a structure by which the valve opens when the pressure increases up to a predetermined pressure, may be used.

By doing so, the flow rate of the ozonated washing water supplied to the membrane is adjusted intermittently and thus, a shearing force by the ozone water in the membrane, namely, a force by the ozone water for displacing or scratching the membrane surface, becomes larger, so that it is possible to more enhance the washing effect. Further, when the pressure is adjusted to that matched to the gas-to-liquid ratio of the high concentration ozone gas and the washing water, it becomes possible to more enhance the dissolution efficiency of the ozone gas. This makes it further possible to control the pressure of the backwashing water to a specified value, for example, within 50 kPa, so that the membrane filtration-separation device 2 can be prevented from breakage, etc.

### Embodiment 5

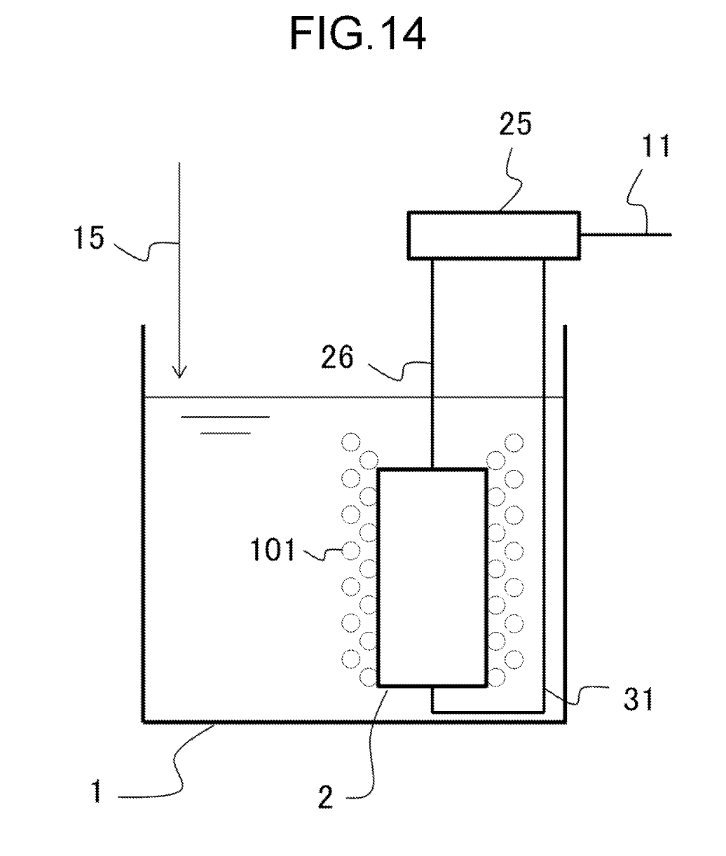

FIG. 14 is a block diagram partially showing an apparatus configuration of an example in Embodiment 5 of the invention.

In contrast to FIG. 1, FIG. 3 or FIG. 8, components are added as follows. The membrane connection pipe 11 is connected to a header 25, and to the header 25, a first membrane connection pipe 26 and a second membrane connection pipe 31 are respectively connected. The first membrane connection pipe 26 and the second membrane connection pipe 31 are connected together in the membrane filtration-separation device 2. It is preferable that the membrane connection pipe 26 and the second membrane connection pipe 31 be placed at mutually opposing positions on the membrane filtration-separation device 2 as a membrane module. Because ozone is consumed by its reaction with the fouling substance in the membrane module, when the ozonated washing water is supplied also from the mutually opposing position on the membrane filtration-separation device 2, the ozone water concentration in the membrane filtration-separation device can be made uniform. Further, the header 25 serves to equally distribute the ozonated washing water into portions flowing through the membrane connection pipe 26 and the second membrane connection pipe 31 to enter the membrane filtration-separation device 2.

Next, operations will be described. At the time of membrane filtration, the filtered water is sent through the respective pipes of the first membrane connection pipe 26 and the second membrane connection pipe 31 to the washing water tank 3. In contrast, at the time of backwashing, a pressure-buffering function works in the header 25, so that the ozonated washing water, as washing water, is supplied through the first membrane connection pipe 26 and the second membrane connection pipe 31 uniformly into the membrane filtration-separation device (due to connection of the header 25, uniformity is established), thus making it possible to uniformly wash the inside of the membrane and the membrane surface. Note that if the ozonated washing water, as washing water, can not be supplied uniformly, a non-washable portion emerges in the membrane.

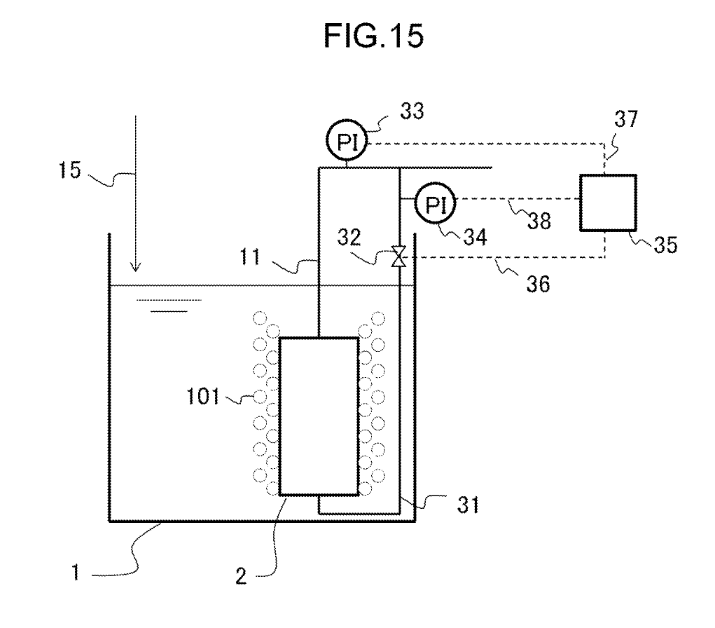

In addition, FIG. 15 is a block diagram partially showing an apparatus configuration of another example in Embodiment 5 of the invention. In contrast to FIG. 1, FIG. 3 or FIG. 8, components are added as follows. That is, the washing water enters a washing water adjusting valve 32 in a branched manner from the membrane connection pipe 11, and the washing water is to be supplied through the membrane connection pipe 11 and the washing water adjusting valve 32 to the membrane filtration-separation device 2, so that a second membrane connection pipe 31 is branched from the membrane connection pipe 11, and these pipes are each connected to the membrane filtration-separation device 2. The membrane connection pipe 11 and the second membrane connection pipe 31 are connected together in the membrane filtration-separation device 2. To the membrane connection pipe 11 and the second membrane connection pipe 31, a membrane-connection-pipe pressure indicator 33 and a second membrane-connection-pipe pressure indicator 34 are connected, respectively, and these pressure indicators are connected to a control device 35 through a pressure-indicator signal line 37 for the membrane connection pipe and a pressure-indicator signal line 38 for the second membrane connection pipe, respectively. Further, to the second membrane connection pipe 31, the washing water adjusting valve 32 as a flow-rate adjusting valve for washing water is attached, and the washing water adjusting valve 32 is connected through a valve control line 36 to the control device 35.

Next, operations will be described. At the time of backwashing, the pressure values of the membrane-connection-pipe pressure indicator 33 and the second membrane-connection-pipe pressure indicator 34 are transmitted as signals to the control device 35 through the pressure-indicator signal line 37 for the membrane connection pipe and the pressure-indicator signal line 38 for the second membrane connection pipe, respectively. Then, a signal is transmitted through the valve control line 36 to the washing water adjusting valve 32 to thereby adjust the valve openness so that the above values become equal to each other. Accordingly, the ozonated washing water, as washing water, is constantly supplied through the membrane connection pipe 11 and the second membrane connection pipe 31 uniformly into the membrane filtration-separation device 2, so that it is possible to uniformly wash the inside of the membrane and the membrane surface.

### Embodiment 6

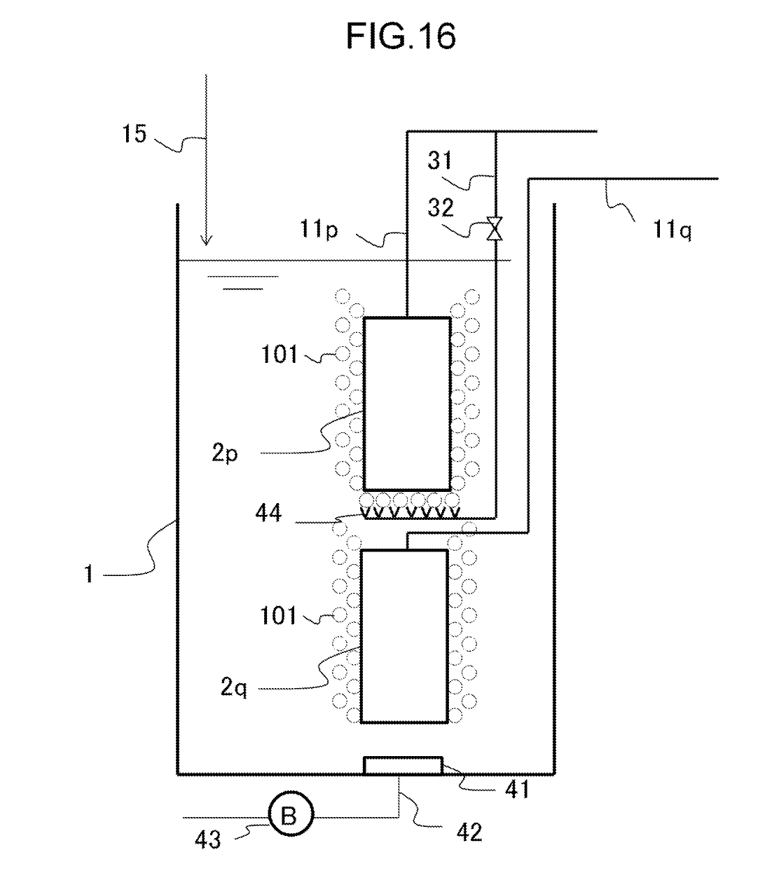

FIG. 16 a block diagram partially showing an apparatus configuration of an example in Embodiment 6 of the invention.

In this embodiment, the membrane filtration-separation device 2 is separated into upper-lower two stages. Further, in contrast to FIG. 1, FIG. 3 or FIG. 8, components are added as follows. To an upper-stage membrane filtration-separation device 2p and a lower-stage membrane filtration-separation device 2q, an upper-stage membrane connection pipe 11p and a lower-stage membrane connection pipe 11q are connected, respectively. From the upper-stage membrane connection pipe 11p, the second membrane connection pipe 31 is branched as described previously, and the washing water adjusting valve 32 is attached to the second membrane connection pipe 31. The end of the second membrane connection pipe 31 is placed below the upper-stage filtration-separation device 2p, and a plurality of ozonated-water suppling elements 44 are mounted on that end. The ozonated-water suppling elements 44 serve to supply the ozonated washing water from below the membrane filtration-separation device 2p to the membrane filtration-separation device 2p, and when the ozonated washing water is injected into the tank for water to be treated 1, ozone-containing bubbles emerge due to pressure reduction. Furthermore, an air diffuser 41 is placed below the lower-stage membrane filtration-separation device 2q in the tank for water to be treated 1, and connected to a blower 43 through an air supply pipe 42.

Next, operations will be described. At the time of backwashing, the ozonated washing water, as washing water, is supplied through the upper-stage membrane connection pipe 11p and the lower-stage membrane connection pipe 11q to the membrane filtration-separation device 2. When a part of the ozonated washing water supplied to the upper-stage membrane connection pipe 11p is then supplied by way of the second membrane connection pipe 31 and through the ozonated-water supplying elements 44, to the upper-stage membrane filtration-separation device 2p, pressure reduction occurs at the ozonated-water supplying elements 44, so that ozone bubbles 101 each having a diameter of 0.1 μm to 1 mm emerge and slide up on the surface of the upper-stage membrane filtration-separation device 2p, thus making it possible to more enhance the washing effect of the upper-stage membrane filtration-separation device 2p.

At that time, when air is supplied from the air diffuser 41 by using the blower 43, the removal effect of the substance adhered to the membrane surface is further promoted. This enhances the washing effect of the lower-stage membrane filtration-separation device 2q; however, the air from the air diffuser 41 is less likely to hit the upper-stage membrane filtration-separation device 2p, so that a difference occurs between the washing effects of the upper-stage membrane filtration-separation device 2p and the lower-stage membrane filtration-separation device 2q. This difference can be reduced by use of the aforementioned ozone bubbles 101 each having a diameter of 0.1 μm to 1 mm and emerging from the ozonated water supplying elements 44, so that it is possible to make even the washing effects of the upper-stage membrane filtration-separation device 2p and the lower-stage membrane filtration-separation device 11q in the tank for water to be treated 1. In this embodiment, description has been made about the case of placing two membrane filtration-separation devices in upper-lower stages; however, even when membrane filtration-separation devices are placed in three or more stages, applying the similar configuration thereto achieves the similar effect.

### Embodiment 7

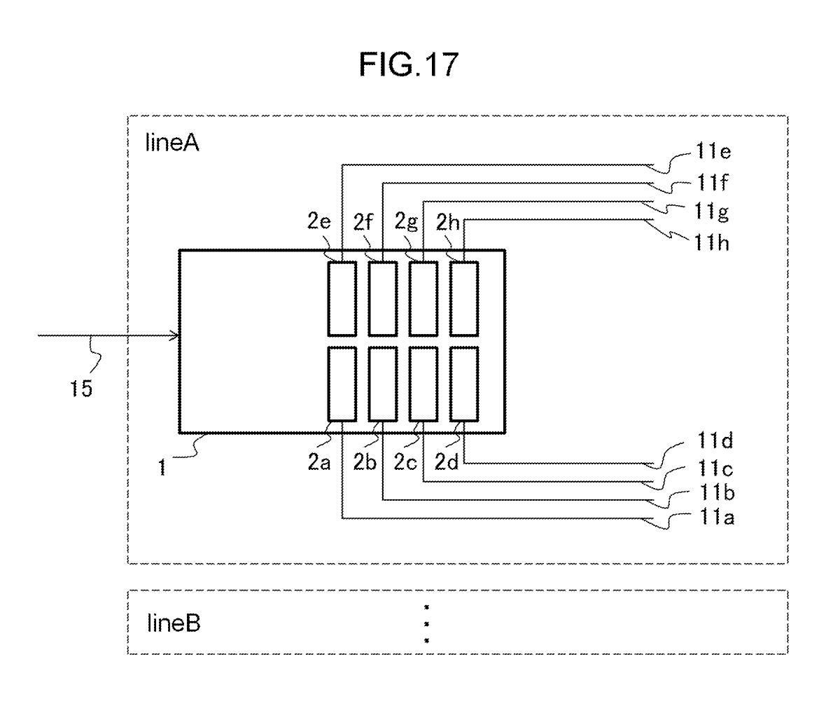

FIG. 17 is a block diagram partially showing an apparatus configuration of an example in Embodiment 7 of the invention.

FIG. 17 shows a flow of the treatment by MBR, and in which eight membrane filtration-separation devices 2a to 2h are placed in the tank for water to be treated 1 in a line A, and to these devices, membrane connection pipes 11a to 11h are connected, respectively. Though not shown in this figure, to the end of each of the membrane connection pipes 11a to 11h, filtration equipment and backwashing equipment having configurations similar to those shown in FIG. 1, FIG. 3 or FIG. 8, are connected. Further, as water for backwashing, the ozonated washing water resulted from dissolving an ozone gas into the washing water may be used. In addition, in this embodiment, a line B with the similar configuration is provided; this is because the number of the membrane filtration-separation devices 2 that can be introduced in the tank for water to be treated 1 is restricted depending on its space and thus, when the sewage volume varies to increase, or the concentration of the organic substance becomes higher to make the processing load about water quality higher, this may result in shortage of the membrane area, so that the required flux may be not achieved. This line B is placed in parallel with the line A and both or only one of them can be employed. Note that, although only two lines are shown in this figure, the treatment may be executed in at least two lines, and thus the lines may be three lines, for example. Further, it is allowable to execute a method in which the number of lines is varied according to the water volume.

In the operation method of this system, when the transmembrane pressure difference of a given one of the membrane filtration-separation devices (for example, 2a) increases up to a preset value, the membrane filtration treatment is suspended and the aforementioned backwashing is executed. After the completion of backwashing, the membrane filtration treatment is restarted.

In this manner, when the transmembrane pressure difference of each of the membrane filtration-separation devices increases up to the preset value, backwashing is executed at said each of the membrane filtration-separation devices; however, if backwashing of them is executed at once, no treated water is obtained during that execution, so that backwashing of the plural membrane filtration-separation devices is not executed at the same time, but is executed sequentially. When the high concentration ozonated washing water is used as the backwashing water, backwashing is completed in a short time, so that no shortage of the filtered water occurs and thus the treated water can be obtained stably. Furthermore, it is also allowable to draw out once the activated sludge in the tank for water to be treated 1 in the line A and then to fill the tank with the ozonated washing water to thereby perform washing. To deal with that case, only the line B is subjected to the operation. In addition, increasing the number of lines makes it possible to enhance the stability of the treatment.

Meanwhile, it is allowable to apply to the line B, instead of MBR, a standard activated sludge method or like method in which the activated sludge is separated in a final sedimentation basin and is then flowed to return to an aeration tank (corresponding to the tank for water to be treated 1 in this embodiment), to thereby perform the parallel operations with MBR. This makes it possible to deal with the trouble in MBR (line A) when it occurs. Further, in the case where not so higher quality is required for the treated water, when the respective treated water by MBR (line A) and by the standard activated sludge method (line B) are mixed together, because the quality of the water treated by MBR is better than the quality of the water treated by the standard activated sludge method, it is possible to easily achieve the required quality of the treated water.

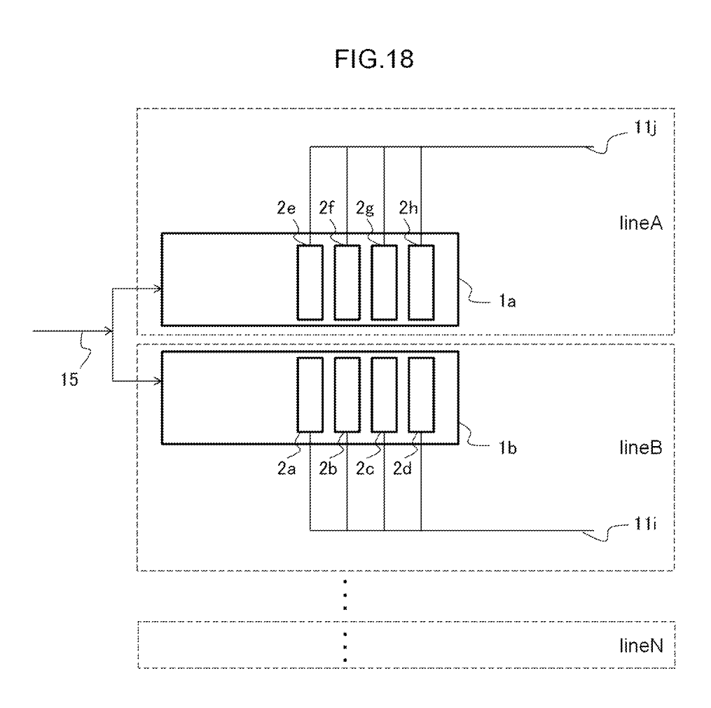

In addition, FIG. 18 shows the case where a treatment line is divided into two or more plural lines. The membrane-filtered water from the respective membrane filtration-separation devices 2a to 2d are collected in a membrane connection pipe 11i, and to its end, filtration equipment and backwashing equipment having configurations similar to those shown in FIG. 1, FIG. 3 or FIG. 8, are connected. Likewise, the membrane-filtered water from the respective membrane filtration-separation devices 2e to 2h are collected in a membrane connection pipe 11j, and filtration equipment and backwashing equipment are connected in a similar manner. Although the basic operation method is the same as that shown in FIG. 16, it is possible to operate in response to the variation in the water treatment volume or to the load about the water quality, for example, to operate while making switching between the line A and the line B. For example, when the water volume or the load about the water quality is small, only a part of the lines is activated, for instance, the line A is suspended and only the line B is activated. This makes it possible to perform more power-saving operation. Furthermore, during backwashing in a given line N, the filtration treatment is not allowed therein; however, adjusting the filtered water volume in a line other than the line N makes it possible to continuous treatment.

### EXAMPLES

With respect to a backwashing method, the four conditions in Examples 1, 2 and Comparative Examples 1, 2 that are shown below, were used, and online backwashing was executed. Evaluation is made about a variation per day in the membrane filtration resistance in MBR. The operation condition of MBR is shown in Table 1.

TABLE 1

| Nature of | Raw sewage after | |
|---|---|---|
| Water to be Treated | screen treatment | |
| Water-Quality of | BOD: 159 mg/L | |
| Water to be Treated | COD: 244 mg/L | |
| | SS: 123 mg/L | |
| Water-Temperature of | 25° | C. |
| Water to be Treated | | |
| Tank Capacity of | 35 | L |
| Water to be Treated | | |
| Retention Time (HRT) | 10 | hours |
| Flow Rate of | 55 | L/day |
| Water to be Treated | | |
| MLSS Concentration | 9500 | mg/L |
| Flow Rate for Aeration | 2 | L/min. |
| Area of Membrane Filteration | 0.069 | m² |

| | |
|---|---|
| Cycle of Membrane- | Membrane-Filteration |
| Filteration/Backwashing | Treatment Time: 25 min. |
| | Backwashing Time: 1 min. |
| | Down-Time: 3 min. |

### Example 1

As backwashing water, ozonated washing water (concentration: 13 to 15 mg/L) resulted from dissolving an ozone gas into washing water was used, and 380 mL is applied as the volume of the backwashing water. This Example 1 was executed with the block diagram shown in FIG. 3. In Example 1, at the time of backwashing, a large amount of ozone-containing bubbles emerged from the membrane filtration-separation device 2.

### Example 2

As backwashing water, ozonated washing water (concentration: 13 to 15 mg/L) resulted from dissolving an ozone gas into washing water, and an oxalic acid aqueous solution (concentration: 1000 mg/L) were used, and 190 mL is applied to each of them as the volume of the backwashing water. This Example 2 was executed with the block diagram shown in FIG. 12. In Example 2, at the time of backwashing, a large amount of ozone-containing bubbles emerged from the membrane filtration-separation device 2.

### Comparative Example 1

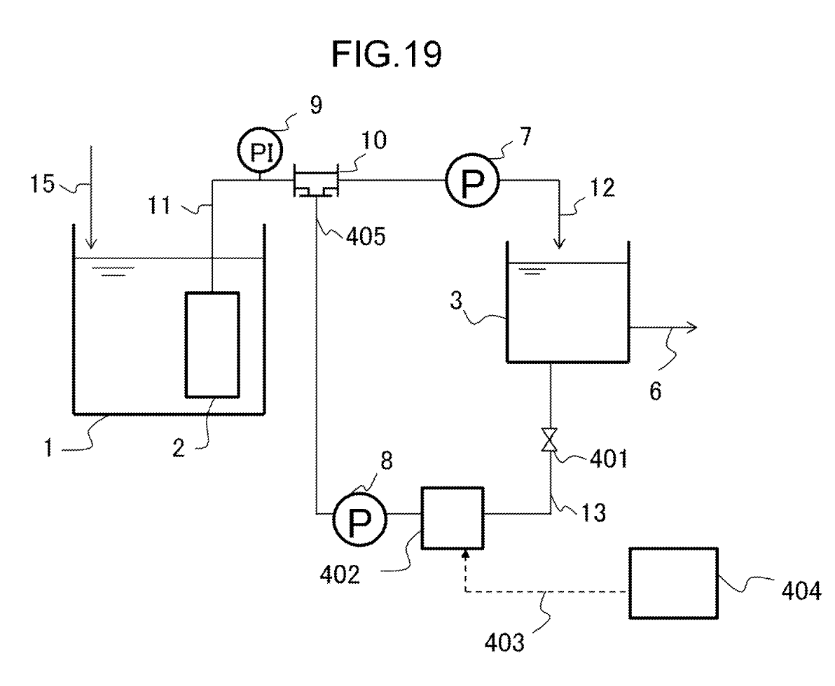

As backwashing water, a sodium hypochlorite aqueous solution (concentration: 6000 mg/L) resulted from dissolving sodium hypochlorite into washing water was used, and 380 mL is applied as the volume of the backwashing water. FIG. 19 shows a block diagram for performing backwashing using the sodium hypochlorite aqueous solution. A sodium-hypochlorite-raw-water tank 404 in which a sodium hypochlorite aqueous solution of a concentration of 12% is stored is connected through a sodium-hypochlorite supply pipe 403 to a sodium-hypochlorite-aqueous-solution adjusting tank 402. Further, the washing water tank is connected through the washing water pipe 13 to the sodium-hypochlorite-aqueous-solution adjusting tank 402. Furthermore, the washing-water supply pump 8 and the sodium-hypochlorite-aqueous-solution adjusting tank 402 are connected to each other through a sodium hypochlorite water pipe 405, and the washing-water supply pump 8 and the switching valve 10 are connected to each other. Note that in the washing water pipe 13, a washing water valve 401 is placed. The other configuration is similar to in FIG. 3.

Next, operations will be described. The sodium hypochlorite aqueous solution of a concentration of 12% stored in the sodium-hypochlorite-raw-water tank 404 is sent through the sodium-hypochlorite supply pipe 403 to the sodium-hypochlorite-aqueous-solution adjusting tank 402, so that it is mixed with the filtered water to thereby generate a sodium hypochlorite aqueous solution of a concentration of 6000 mg/L. By using the washing-water supply pump 8, this solution is sent through the sodium hypochlorite water pipe 405, the switching valve 10 and the membrane connection pipe 11 to the membrane filtration-separation device 2, so that backwashing is executed. Note that, in this comparative example, no ozone-containing bubble emerged from the membrane filtration-separation device 2 at the time of backwashing.

### Comparative Example 2

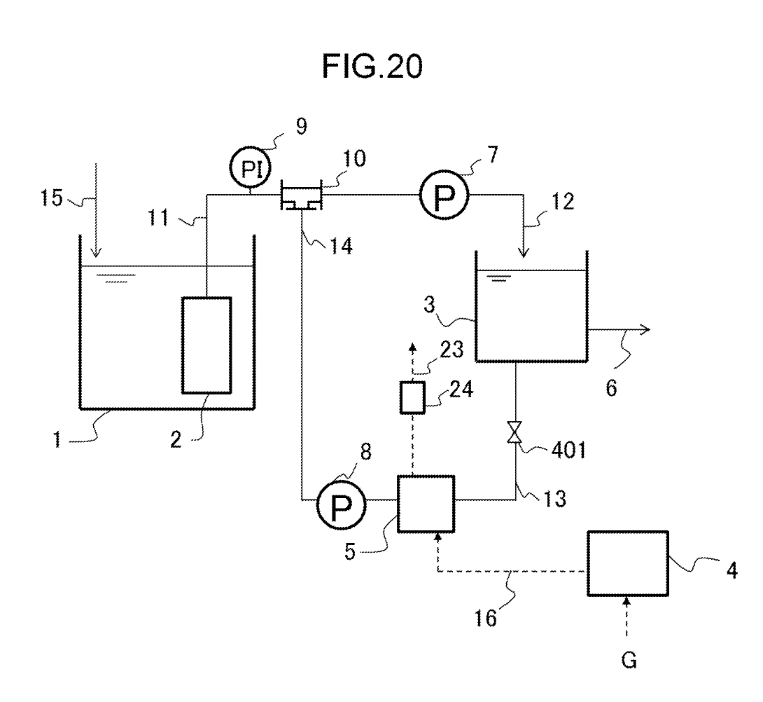

As backwashing water, ozonated washing water (concentration: 2 mg/L) resulted from dissolving an ozone gas into washing water was used, and 380 mL is applied as the volume of the backwashing water. FIG. 20 shows a block diagram for performing backwashing using the ozone water of this comparative example. An ozone mixing tank 5 is connected through a waste ozone-gas pipe 23 to waste ozone-gas treatment equipment 24. The washing-water supply pump 8 is arranged between the switching valve 10 and the ozone mixing tank 5, and is connected to them by way of the ozonated water pipe 14. Further, because the washing-water supply pump 8 makes contact with the ozone water, a pump having an ozone resistance characteristic is used as that pump. Further, the ozonated water pipe 14, the switching valve 10, the membrane connection pipe 11, the pressure indicator 9 and the membrane filtration-separation device 2 also have ozone resistance characteristics. The other configuration is similar to in FIG. 3.

Next, operations will be described. The ozone gas generated by the ozone generator 4 is injected through the ozone gas pipe 16 into the ozone mixing tank 5, so that the zone water is generated. Through the waste ozone-gas pipe 23, undissolved ozone gas is decomposed as a waste ozone gas into oxygen, namely rendered harmless, by the waste ozone-gas treatment equipment 24, and is then released into the atmosphere. Backwashing is executed in such a manner that the ozone water having a concentration of 2 mg/L in the ozone mixing tank 5 is sent by the washing-water supply pump 8 to the membrane filtration-separation device 2 through the ozonated water pipe 14, the switching valve 10 and the membrane connection pipe 11.

Note that, in this comparative example, no ozone-containing bubble emerged from the membrane filtration-separation device 2 at the time of backwashing. This is because, at the time the washing water reaches the membrane filtration-separation device 2, ozone has been entirely consumed by the reaction with the organic substance, etc. in the washing water.

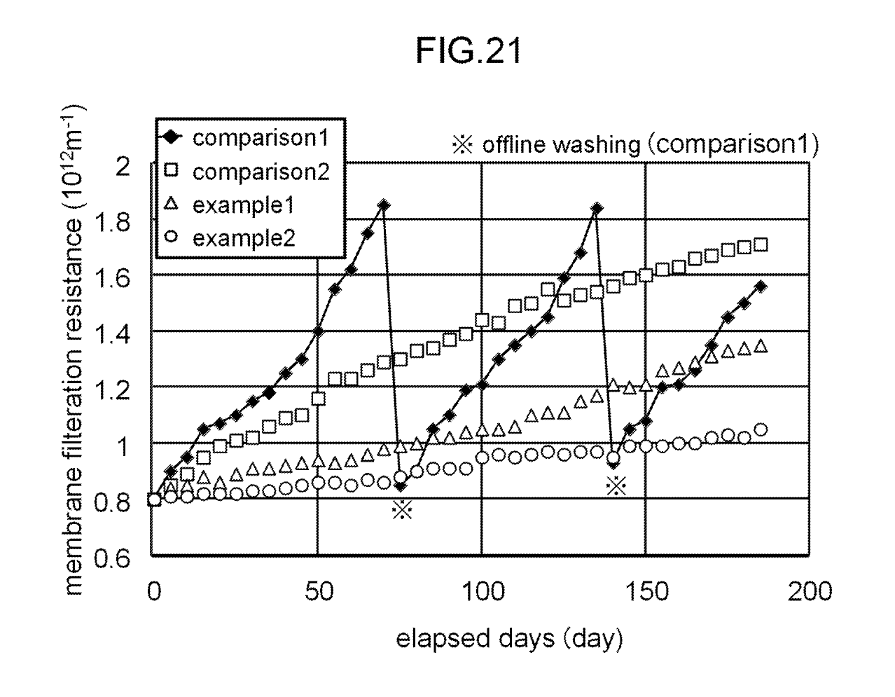

The variations per day in the membrane filtration resistance is shown in FIG. 21. The membrane filtration resistance R is calculated by the following formula (1).

[Formula 1]

R=(ΔP/φ/J (1)

Herein shown are, R: a membrane filtration resistance (m⁻¹), ΔP: a transmembrane pressure difference (Pa), J: a flux of membrane-filtered water (m/day) and ρ: a viscosity coefficient of membrane-filtered water (Pa·s).

In Comparative Example 1, even when backwashing was executed periodically, the membrane filtration resistance increased most drastically in comparison to the other examples, so that it was necessary, in this evaluation period, to execute twice offline washing (dipping in a sodium hypochlorite aqueous solution of 5000 mg/L for 2 hours plus dipping in an oxalic acid aqueous solution of 10000 mg/L for 2 hours). Furthermore, it was observed that, even when the offline washing was executed, the membrane filtration resistance did not recover to the initial state, and at every time the offline washing was repeated, the membrane filtration resistance after the offline washing was apt to increase.

In Comparative Example 2, although not to the extent of Comparative Example 1, the membrane filtration resistance increased gradually. In contrast, in Example 1, the membrane filtration resistance was largely prevented from increasing, in comparison to Comparative Examples 1 and 2. This is because the washing effect by the high concentration ozonated washing water is achieved. Further, in Example 2, the membrane filtration resistance was more prevented from increasing than in Example 1. This is because the oxalic acid aqueous solution is used together with the ozonated washing water, so that removal of not only an organic substance but also an inorganic substance is promoted.

Note that, in every example/comparative example, the quality of the treated water was generally stable as having BOD (Biochemical Oxygen Demand): 4 to 7 mg/L, COD (Chemical Oxygen Demand): 7 to 12 mg/L, and SS: less than 0.5 mg/L. Namely, the water quality was good as its variation being small and the values of BOD, COD and SS falling within the above ranges. Note that the washing water was prepared using this treated water.

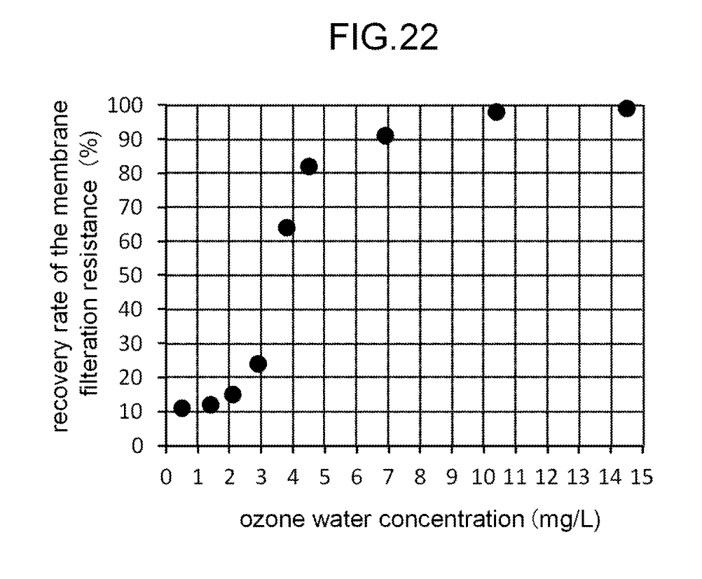

For the membrane subjected to MBR operated in the condition shown in Table 1, the recovery rate of the membrane filtration resistance determined from the transmembrane pressure difference was evaluated in each of the cases where an ozone water concentration near the membrane in the membrane secondary side, namely, at the point in contact with the membrane, was varied from 0.5 to 15 mg/L. The results obtained are shown in FIG. 22. Note that the recovery rate (%) of the membrane filtration resistance to be determined from the transmembrane pressure difference was calculated by the following formula (2). Further, in this case, the ozone water concentration was 1 to 17 mg/L at the time just after injection of the ozone gas. The membrane filtration resistance at the time before use was calculated using the formula (1) from the transmembrane pressure difference at the time purified water was filtered using the unused membrane.

[Formula 2]

Recovery Rate of Membrane Filtration Resistance (%)=100×(Membrane Filtration Resistance Before Washing−Membrane Filtration Resistance After Washing)/(Membrane Filtration Resistance Before Membrane Washing−Membrane Filtration Resistance Before Use) (2)

As shown in FIG. 22, when the ozone water concentration is made higher than 3 mg/L, the recovery rate of the membrane filtration resistance determined from the transmembrane pressure difference increases sharply to reach near 100% at the ozone water concentration of 10 mg/L. Namely, it is found that, when the ozone water concentration becomes higher, the recovery rate of the membrane filtration resistance determined from the transmembrane pressure difference becomes higher, so that the flux of the value as designed is achieved stably, namely, for a long period (a period of several tens of days to several hundreds of days), and thus the membrane filtration treatment can be executed with a high flux.

### Example 3

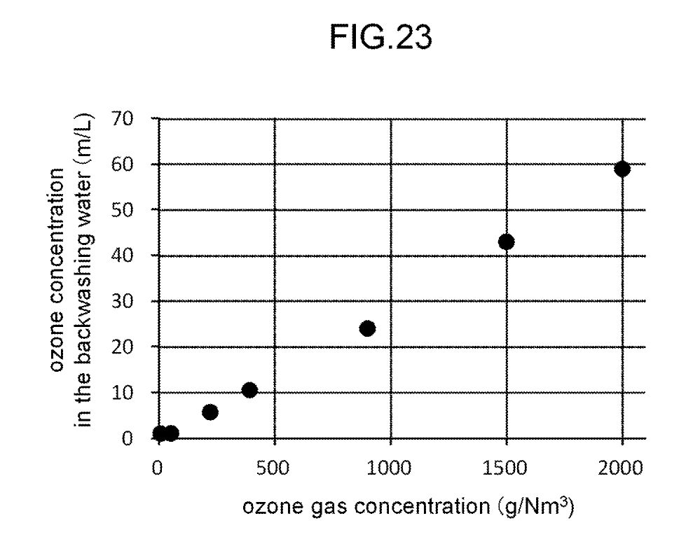

In addition, with the condition shown in Table 1, the ozone-gas concentration dependence was evaluated for the case of condensing an ozone gas as shown in FIG. 8, the results of which are shown in FIG. 23 to FIG. 25. Note that the ozone gas was condensed when the ozone gas concentration was 220 g/m³ or more. Further, as backwashing water, the treated water was used, and the ozone injection rate (an injection amount of ozone per unit volume of the treated water) was set to 85 mg/L.

FIG. 23 shows a variation of the ozone concentration in the backwashing water relative to the ozone gas concentration. As shown in this figure, such a result is obtained that the higher the ozone gas concentration, the higher the ozone concentration in the backwashing water becomes. In particular, when the ozone gas concentration was 50 g/Nm³ or less, the ozone concentration in the backwashing water was low to be about 1 mg/L, so that a sufficient washing effect was not obtained. This is because an organic substance remaining in the treated water reacted with ozone, so that ozone was consumed invalidly. Namely, when the ozone gas concentration becomes higher, the invalidly-consumed amount of ozone becomes smaller, and as the result, the backwashing water of high ozone concentration can be generated.

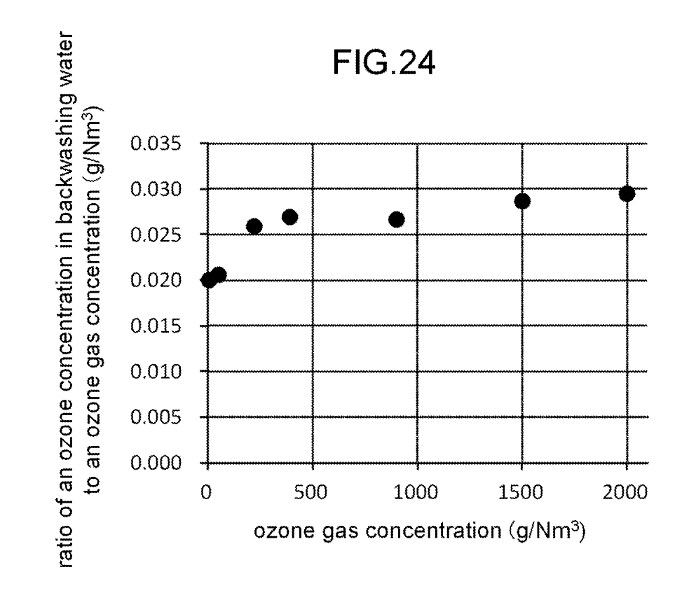

FIG. 24 shows a ratio of the ozone concentration in the backwashing water to the ozone gas concentration, relative to the ozone gas concentration. As shown in this figure, it is found that, when the ozone gas concentration is 50 g/Nm³ or less, the ratio is small, and when the ozone gas concentration is set to 220 g/Nm³ or more, ozone in the gas can be converted efficiently into ozone in the backwashing water.

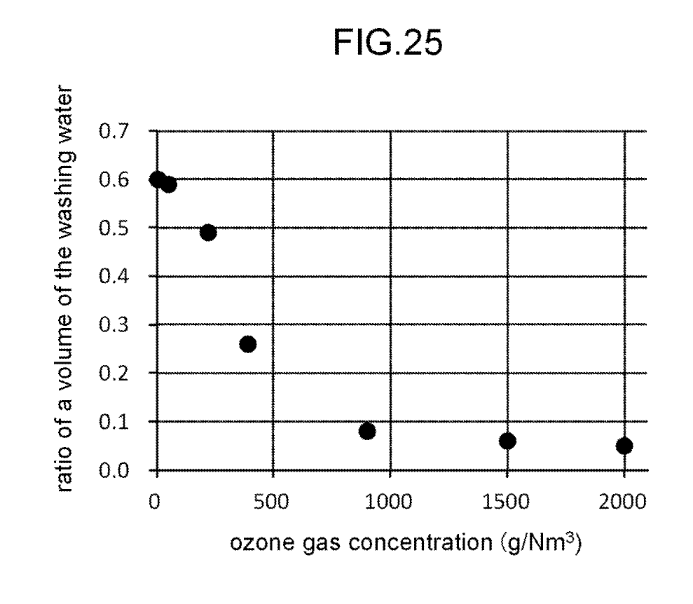

FIG. 25 shows a variation, relative to the ozone gas concentration, in the ratio of a volume of the washing water of sodium hypochlorite solution of 6000 mg/L concentration required for the transmembrane pressure difference to recover up to 100%, to a volume of the ozone backwashing water required for the transmembrane pressure difference to recover up to 100%. When the ozone gas concentration is 50 g/Nm3 or less, the volume ratio of washing water is approximately 0.6, and when the ozone gas concentration is set to 220 g/Nm3 or more, the volume of the backwashing water decreases drastically. Namely, as the ozone gas concentration becomes higher, the water volume required for backwashing can be made lower. Namely, this means that, as the ozone gas concentration becomes higher, the volume of treated water required for backwashing is allowed to be smaller, and thus the recovery rate of the treated water by MBR becomes higher. Further, because the comparison is made with the same ozone injection rate, an ozone amount required for backwashing, namely, a product of the ozone injection rate and the volume of the backwashing water, becomes lower as the ozone gas concentration becomes higher, and this makes possible a more efficient treatment.

It should be noted that unlimited combination of the respective embodiments may be made, and any modification in the embodiments and any omission in the embodiments may be made appropriately, in the present invention without departing from the scope of the invention.

### DESCRIPTION OF REFERENCE NUMERALS AND SIGNS

1: tank for water to be treated, 2: membrane filtration-separation device, 3: washing water tank, 4: ozone generator, 5: ozone mixing tank, 6: treated water pipe, 7: filtration pump, 8: washing-water supply pump, 9: pressure indicator, 10: switching valve, 11: membrane connection pipe, 12: filtered water pipe, 13: washing water pipe, 14: ozonated water pipe, 15: pipe for water to be treated, 16: ozone gas pipe, 17: ozone-gas storage tank, 18: oxygen gas pipe, 19: acid storage tank, 20: acid supply pump, 21: acid supply pipe, 22: pressure adjusting valve, 23: waste ozone-gas pipe, 24: waste ozone-gas treatment equipment, 25: header, 26: first membrane connection pipe, 27: dehumidifier, 28: pressure relief valve, 30: backwashing water tank, 31: second membrane connection pipe, 32: washing water adjusting valve, 33: membrane-connection-pipe pressure indicator, 34: second membrane-connection-pipe pressure indicator, 35: control device, 36: valve control line, 37: pressure-indicator signal line for the membrane connection pipe, 38: pressure-indicator signal line for the second membrane connection pipe, 41: air diffuser, 42: air supply pipe, 43: blower, 44: ozonated water supplying elements, 51: ozone water circulating pump, 52: ejector, 53: ozone water circulating pipe, 101: ozone bubbles (ozone-containing bubbles), 201: excessive-sludge withdrawing pump, 202: sludge circulating pump, 203: excessive-sludge withdrawing pipe, 204: sludge circulating pipe, 205: air diffuser, 301: ozone reaction tank, 302: ozone-treated water pipe, 303: ozone gas pipe for treated water, 304: waste ozone-gas pipe for treated water, 305: waste ozone-gas treatment equipment for treated water, 306: waste ozone-gas recycling pipe, 307: waste ozone-gas switching valve, 401: washing water valve, 402: sodium-hypochlorite-aqueous-solution adjusting tank, 403: sodium-hypochlorite supply pipe, 404: sodium-hypochlorite-raw-water tank, 405: sodium hypochlorite water pipe, 501: ozone reaction tank, 504: waste ozone-gas pipe for treated water, 505: waste ozone-gas treatment equipment for treated water, 506: waste ozone-gas recycling pipe, 507: waste ozone-gas switching valve,
2a: first membrane filtration-separation device in line A, 2b: second membrane filtration-separation device in line A, 2c: third membrane filtration-separation device in line A, 2d: fourth membrane filtration-separation device in line A, 2e: fifth membrane filtration-separation device in line A, 2f: sixth membrane filtration-separation device in line A, 2g: seventh membrane filtration-separation device in line A, 2h: eighth membrane filtration-separation device in line A, 2p: upper-stage membrane filtration-separation device, 2q: lower-stage membrane filtration-separation device, 11a: first membrane connection pipe in line A, 11b: second membrane connection pipe in line A, 11c: third membrane connection pipe in line A, 11d: fourth membrane connection pipe in line A, 11e: fifth membrane connection pipe in line A, 11f: sixth membrane connection pipe in line A, 11g: seventh membrane connection pipe in line A, 11h: eighth membrane connection pipe in line A, 11i, 11j1: membrane connection pipe, 11p: upper-stage membrane connection pipe, 11q: lower-stage membrane connection pipe.

1: A water treatment method using a membrane, for treating untreated water by passing the untreated water from a filtration primary side of the membrane for membrane filtration to a filtration secondary side of the membrane, comprising:
pressurizing washing water for washing the membrane;
injecting an ozone gas into the pressurized washing water to generate ozonated washing water; and
supplying the ozonated washing water from the filtration secondary side to the filtration primary side, thereby causing, while washing the inside of the membrane, ozone-containing bubbles to emerge in the filtration primary side to thereby wash a surface of the membrane placed in the filtration primary side.

2: The water treatment method using a membrane of claim 1, wherein a pressure of the ozonated washing water is reduced using a pressure relief valve for reducing the pressure of the ozonated washing water that is placed between the membrane and waste ozone-gas equipment for exhausting undissolved ozone gas/oxygen remaining in the ozonated washing water.

3: The water treatment method using a membrane of claim 1, wherein at the time of washing the membrane, a supply pressure of the ozonated washing water is varied.

4: The water treatment method using a membrane of claim 1, wherein the washing water is stored in a washing water tank; and
wherein, when the stored washing water is sent to the membrane through a membrane connection pipe connected to a membrane filtration-separation device in which a foreign substance contained in the untreated water not treated by the membrane filtration and the filtered water are separated from each other, a pressure of the washing water is measured by a pressure indicator placed on the membrane connection pipe, so that after the pressure reaches a predetermined pressure, generation of the ozonated washing water is performed to thereby start a backwashing treatment in which the ozonated washing water is passed from the filtration secondary side to the filtration primary side.

5: The water treatment method using a membrane of claim 1, wherein the ozone gas that is being stored is injected into the washing water.

6: The water treatment method using a membrane of claim 1, wherein, before or after washing the inside of the membrane using the ozonated washing water, an acid is added to the washing water and the acid-added washing water is supplied to the membrane from the filtration secondary side to thereby wash the membrane.

7: A water treatment apparatus using a membrane, comprising:
a membrane filtration-separation device that has a membrane for membrane filtration used for performing a membrane filtration treatment by passing untreated water from a filtration primary side to a filtration secondary side, and that separates from each other, a foreign substance contained in the untreated water not treated by membrane filtration and filtered water obtained by the membrane filtration treatment;
a washing water supply pump for pressuring and supplying washing water used for washing the membrane for membrane filtration;
an ozone generator that supplies an ozone gas;
an ozone dissolver that is connected through a pipe to the washing water supply pump and the ozone generator, that
generates ozonated washing water by dissolving the ozone gas supplied by the ozone generator in the washing water pressurized and supplied by the washing water supply pump, and that supplies the ozonated washing water to the membrane filtration-separation device; and
a switching valve for switching between the membrane filtration treatment in which the untreated water is passed from the filtration primary side to the filtration secondary side, and a backwashing treatment in which the ozonated washing water is passed from the filtration secondary side to the filtration primary side;
wherein, by the backwashing treatment, a surface of the membrane for membrane filtration in the filtration primary side is washed together with an inside of the membrane.

8: The water treatment apparatus using a membrane of claim 7, comprising, between the ozone generator and the ozone dissolver, an ozone-gas storage part in which the ozone gas is stored.

9: The water treatment apparatus using a membrane of claim 7, comprising a configuration element by which an acid is added to the washing water, wherein at the time of the backwashing treatment that is a washing treatment in a direction opposite to that of the normal membrane filtration that is normal, the acid-added washing water is supplied to the membrane for the membrane filtration to thereby wash that membrane.

10: The water treatment apparatus using a membrane of claim 7, comprising:
a membrane connection pipe connected to the membrane filtration-separation device and placed between the membrane filtration-separation device and the switching valve, for sending the ozonated washing water that is pressurized, to the membrane filtration-separation device at the time of the backwashing treatment;
a pressure relief valve connected to the membrane connection pipe, for adjusting a pressure of the ozone gas; and
waste ozone-gas treatment equipment by which an ozone gas undissolved in the pressurized ozonated washing water is exhausted and decomposed into oxygen.
